(19) United States
(12) Patent Application Publication
(10) Pub. No.: US 2016/0000653 A1
(43) Pub. Date: Jan. 7, 2016

(54) TRANSFER SET

(71) Applicant: BAYER HEALTHCARE LLC, Whippany, NJ (US)

(72) Inventor: Peter Kramer, Austin, TX (US)

(21) Appl. No.: 14/770,216

(22) PCT Filed: Mar. 14, 2014
(86) PCT No.: PCT/US2014/027120

§ 371 Date: Aug. 25, 2015

Related U.S. Application Data
(60) Provisional application No. 61/784,512, filed on Mar. 14, 2013.

(51) Int. Cl. A61J 1/20; A61J 1/14

(52) U.S. Cl. CPC A61J 1/2096; A61J 1/1406; A61J 1/201; A61J 1/2048

(57) ABSTRACT

A transfer set generally includes an outer sleeve configured for connecting an inner sleeve to a vial such that a passage of the inner sleeve is disposed above a stopper of the vial. The transfer set further includes a cap configured for insertion into the outer sleeve such that the cap is connected to the outer sleeve and is detachable from the outer sleeve via rotation of the cap relative to the outer sleeve. The cap has an interior space and a cam disposed within the interior space, wherein the inner sleeve, and a spike within the inner sleeve, extend into the interior space when the cap is connected to the outer sleeve, and wherein, as the cap rotates relative to the outer sleeve for detachment of the cap from the outer sleeve, the cam interacts with the follower to translate the spike toward the stopper for puncturing the stopper.

### BACKGROUND

The foregoing disclosure relates generally to transfer sets and, more particularly, to a device for transferring fluid into, or out of, a container.

Many conventional transfer sets attach to a sealed container and include a puncture device that breaks the seal of the container, thereby permitting fluid transfer with the container. To operate these conventional transfer sets, a user-applied force is often required to displace the puncture device for breaking the seal. However, in some instances, proper operation of the transfer sets can be difficult for a user.

There is a need, therefore, for a transfer set that is easier to use.

### SUMMARY

In one embodiment, a transfer set for transferring liquid into or out of a vial sealed by a stopper generally comprises an inner sleeve having a passage extending through the inner sleeve along a longitudinal axis, and an outer sleeve configured for connecting the inner sleeve to the vial such that the passage is disposed above the stopper of the vial. The transfer set further comprises a spike including a follower, wherein the spike is disposed within the passage of the inner sleeve and is configured for longitudinal translation along the passage to puncture the stopper, and a cap configured for insertion into the outer sleeve such that the cap is connected to the outer sleeve and is detachable from the outer sleeve via rotation of the cap relative to the outer sleeve. The cap includes a closed top wall, an annular side wall extending from the closed top wall to define an open bottom and an interior space of the cap, and a cam disposed within the interior space, wherein the inner sleeve and the spike extend into the interior space when the cap is connected to the outer sleeve, and wherein, as the cap is rotated relative to the outer sleeve for detachment of the cap from the outer sleeve, the cam interacts with the follower to translate the spike toward the stopper for puncturing the stopper.

In another embodiment, a transfer set for transferring liquid into or out of a vial sealed by a stopper generally comprises a first conjoint unit including an inner sleeve and a spike disposed within the inner sleeve, wherein the inner sleeve is configured for seating on the stopper of the sealed vial and wherein the spike is configured for translation within the inner sleeve to puncture the stopper. The transfer set further comprises a second conjoint unit including an outer sleeve and a cap connected to the outer sleeve such that the cap is detachable from the outer sleeve by rotating the cap relative to the outer sleeve. The outer sleeve is configured for connection to the inner sleeve in a first connected state, in which the first conjoint unit is removably connected to the sealed vial, and a second connected state, in which the first conjoint unit is irremovably connected the sealed vial, the first conjoint unit and the second conjoint unit being aligned along a longitudinal axis when the second conjoint unit is connected to the first conjoint unit. By applying a longitudinal force to the second conjoint unit when the second conjoint unit is connected to the first conjoint unit, the second conjoint unit is configured for longitudinal displacement relative to the first conjoint unit to convert the connection of the second conjoint unit and the first conjoint unit from the first connected state to the second connected state. By rotating the cap relative to the outer sleeve to detach the cap from the outer sleeve in the second connected state, the cap translates the spike to puncture the stopper.

In yet another embodiment, a transfer set for transferring liquid into or out of a vial sealed by a stopper generally comprises a sleeve including a passage extending through the sleeve along a longitudinal axis, wherein the sleeve is configured for connection to the vial such that the passage is disposed above the stopper. The transfer set also comprises a spike disposed within the passage and configured for longitudinal translation along the passage to puncture the stopper when the sleeve is connected to the vial, the spike having a follower surface. The transfer set further comprises a cap including a cam surface, the cap being rotatably connected to the sleeve such that the cam surface contacts the follower surface. Rotating the cap causes the cam surface of the cap to interact with the follower surface of the spike to translate the spike toward the stopper for puncturing the stopper, wherein the follower surface has a slope that varies along the follower surface.

### BRIEF DESCRIPTION

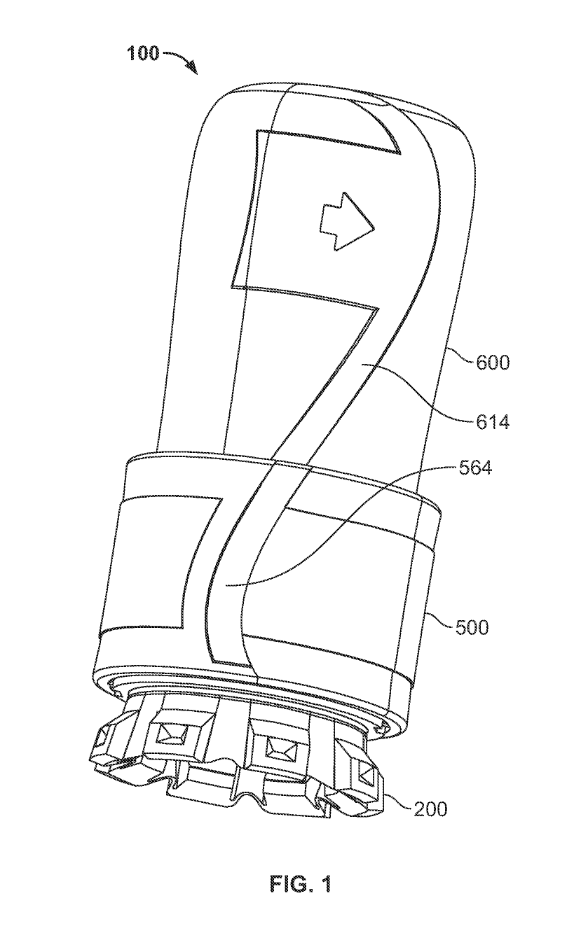

FIG. 1 is a perspective view of one embodiment of a transfer set;

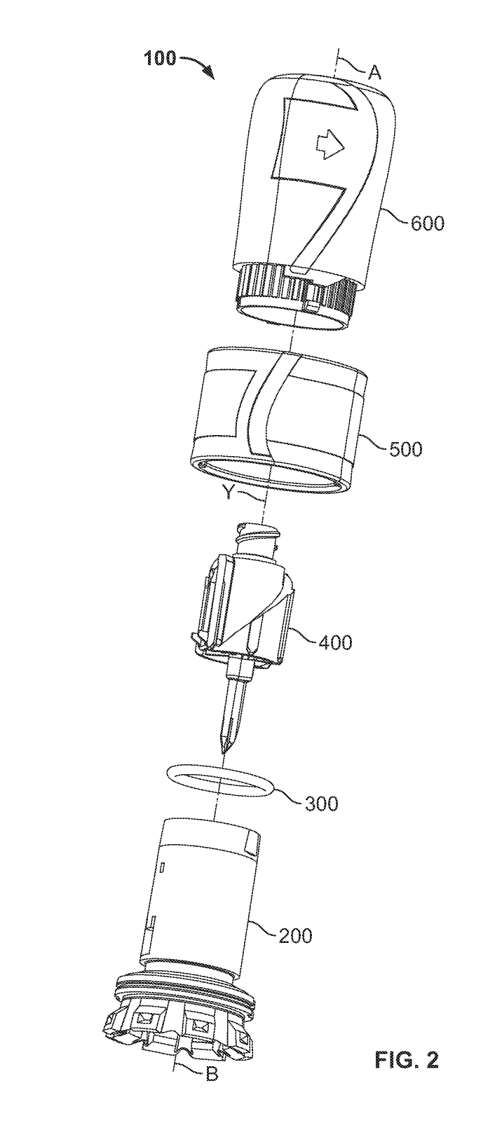

FIG. 2 is an exploded view of the transfer set of FIG. 1;

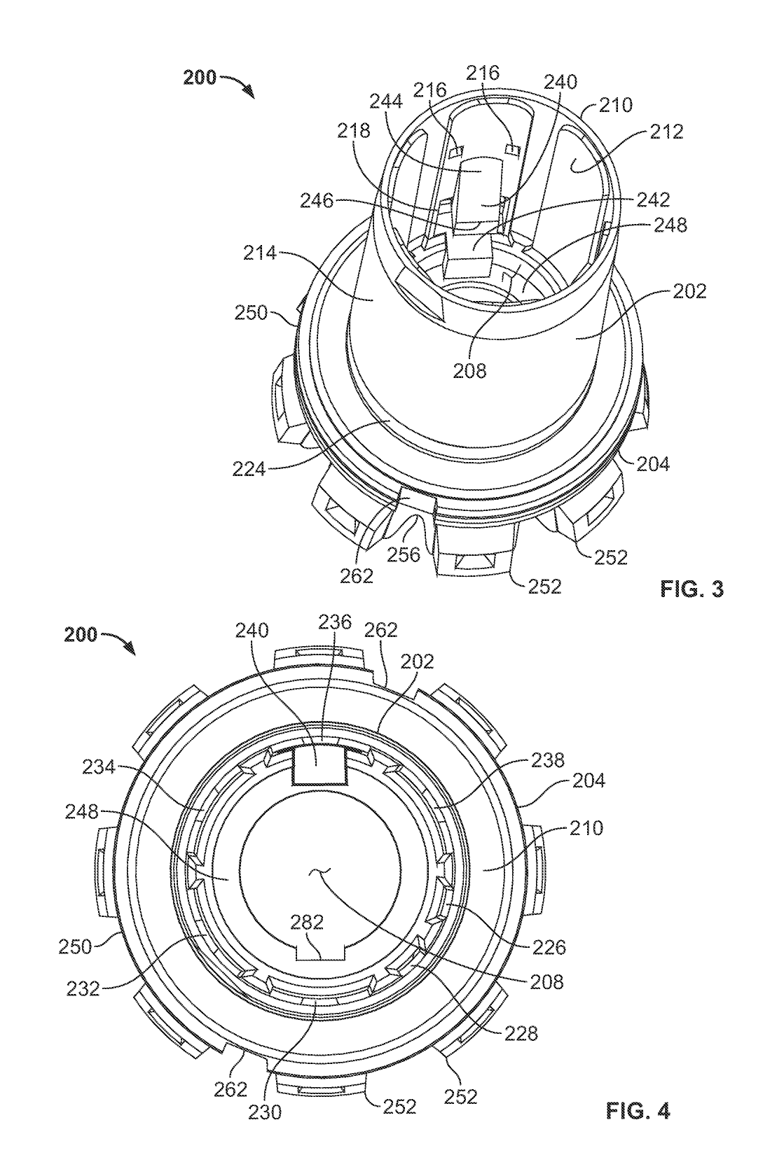

FIG. 3 is a top perspective view of an inner sleeve of the transfer set of FIGS. 1 and 2;

FIG. 4 is a top plan view of the inner sleeve of FIG. 3;

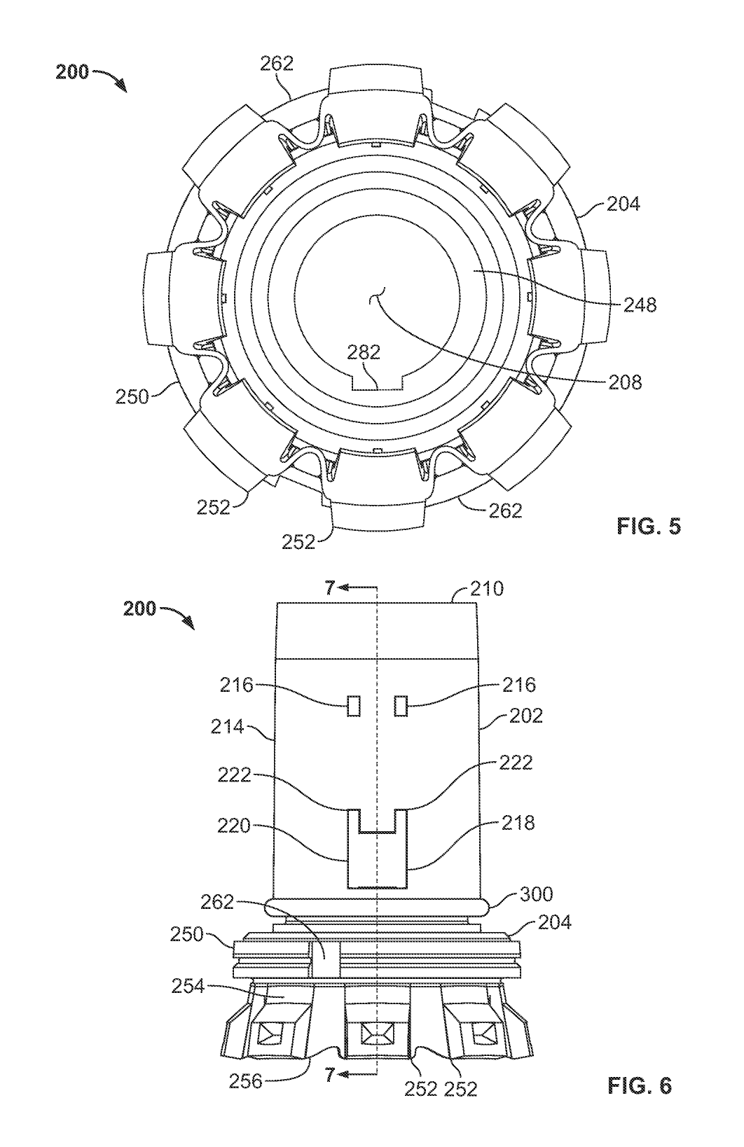

FIG. 5 is a bottom plan view of the inner sleeve of FIG. 3;

FIG. 6 is a side elevation of the inner sleeve of FIG. 3 with a gasket seated thereon;

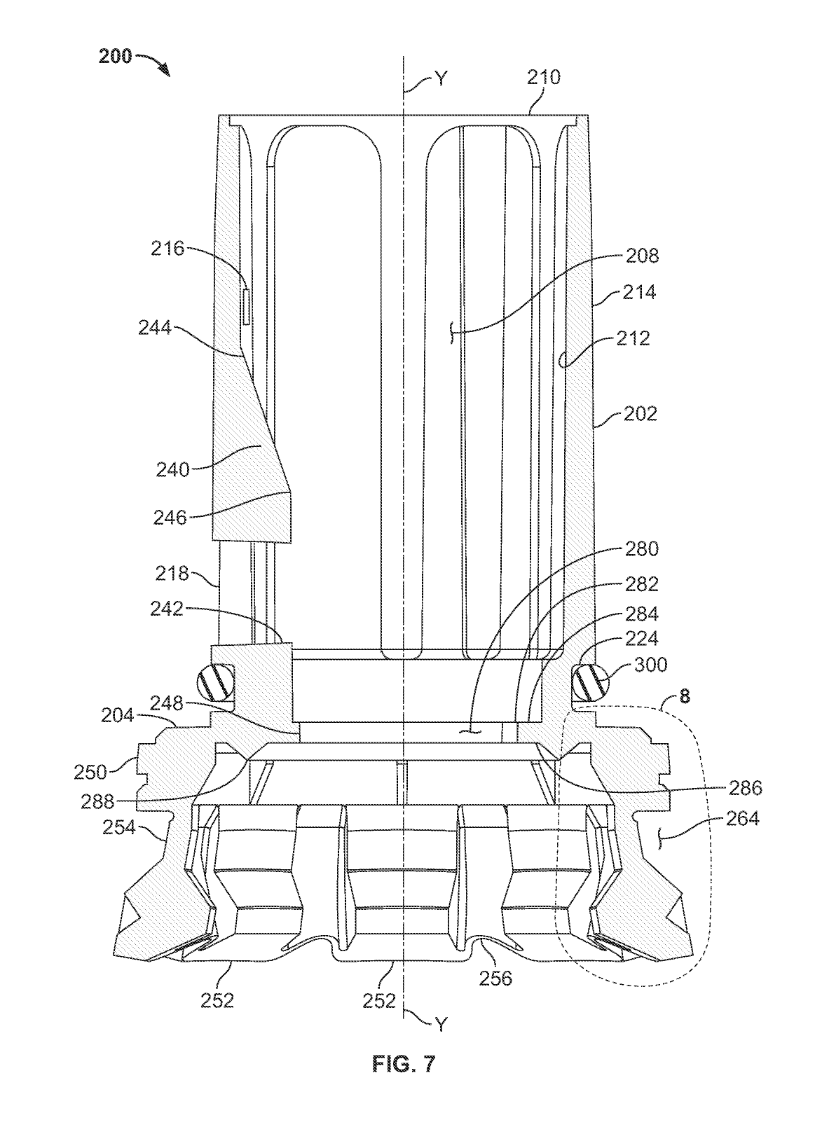

FIG. 7 is a cross-sectional view taken along the plane 7-7 of FIG. 6;

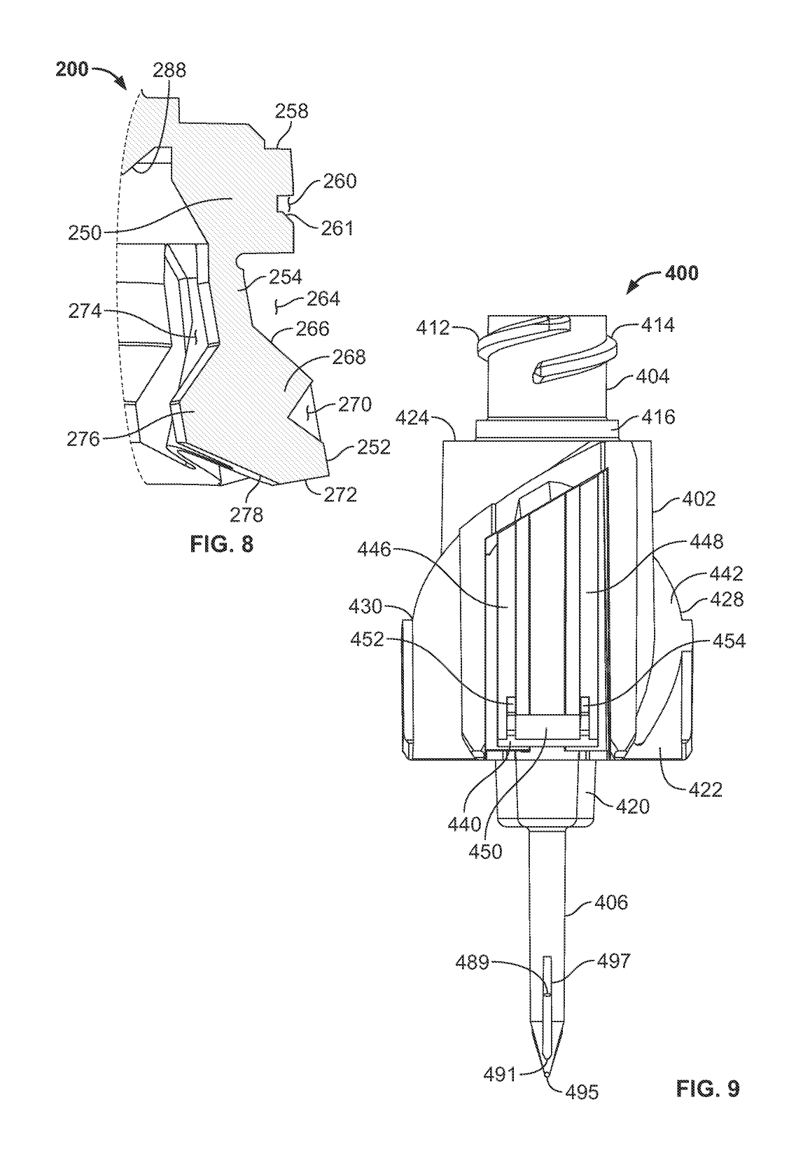

FIG. 8 is an enlarged portion of the cross-sectional view of FIG. 7 taken within region 8;

FIG. 9 is a side elevation of a spike of the transfer set of FIGS. 1 and 2;

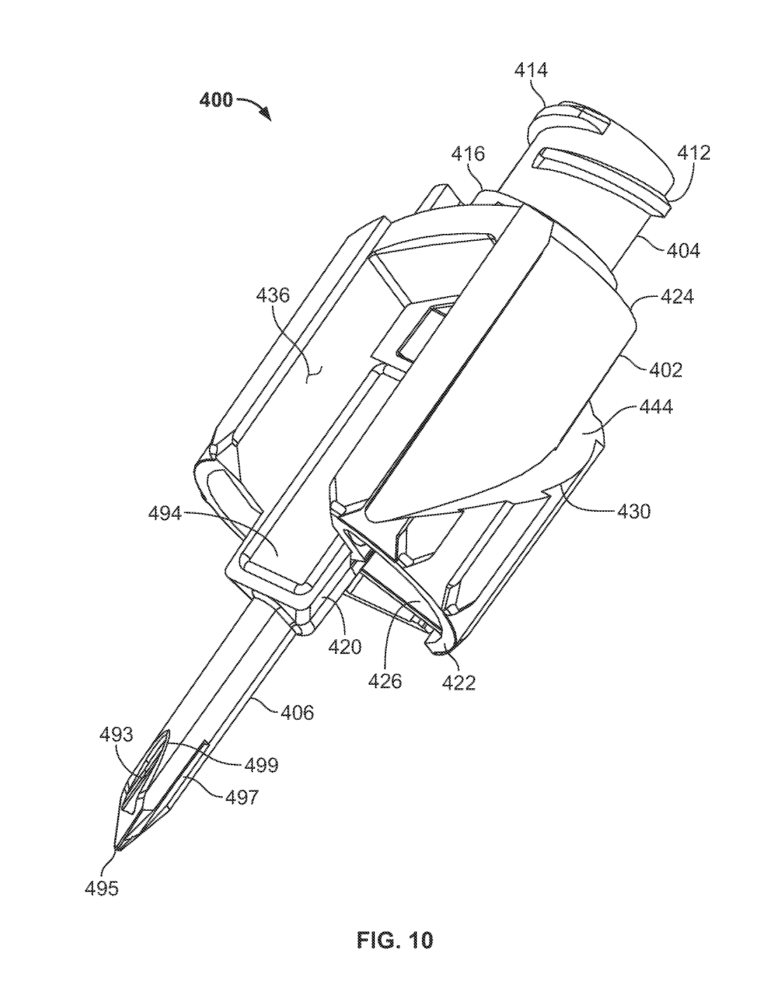

FIG. 10 is a perspective view of the spike of FIG. 9;

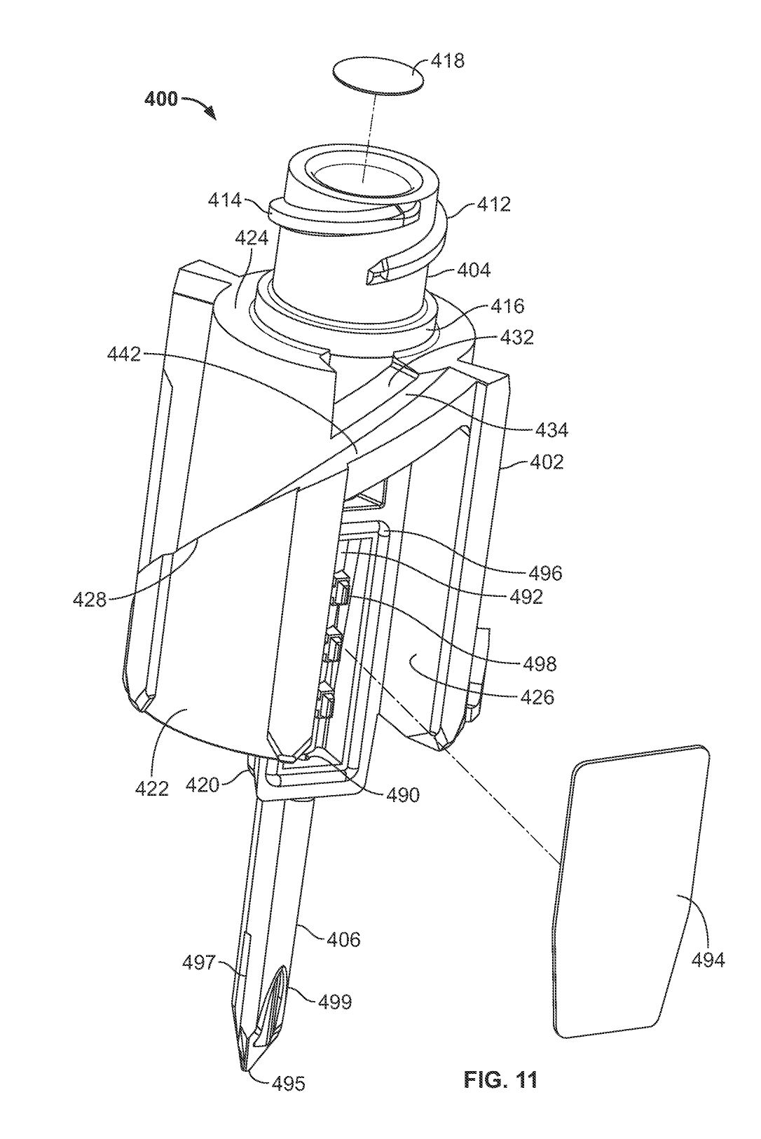

FIG. 11 is a partially exploded view of the spike of FIG. 9;

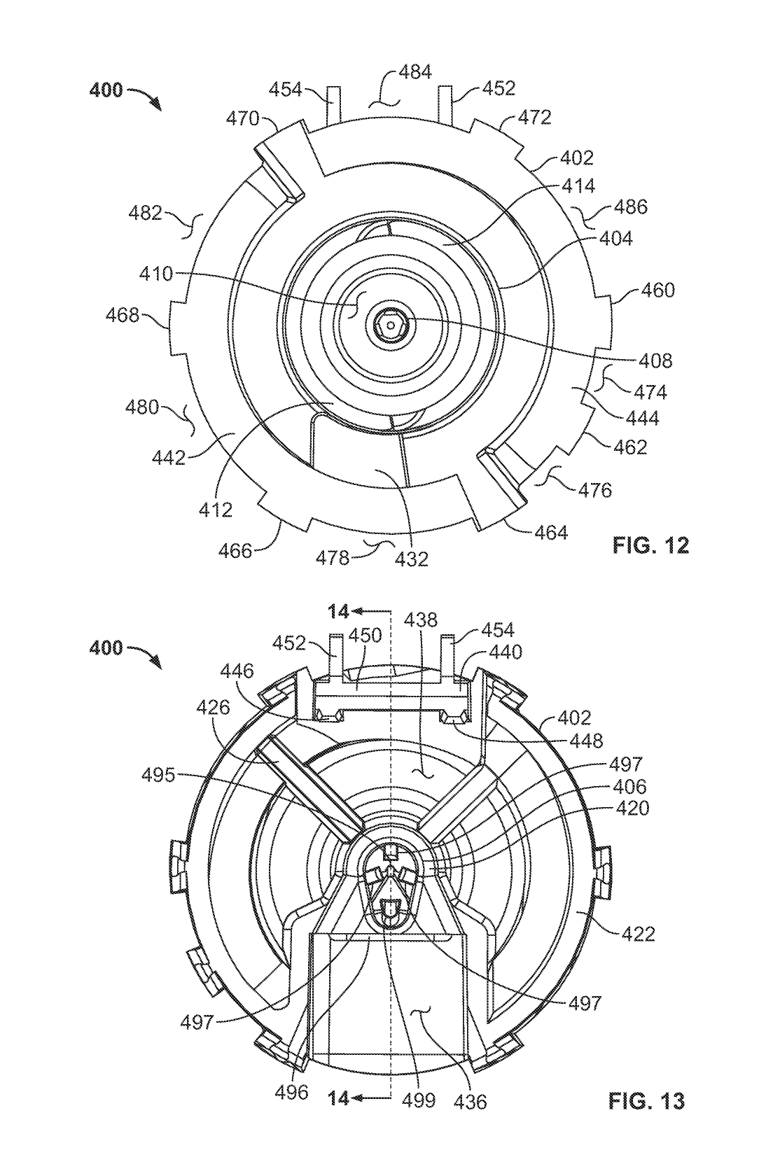

FIG. 12 is a top plan view of the spike of FIG. 12 with a liquid filter and an air filter removed therefrom;

FIG. 13 is a bottom plan view of the spike of FIG. 12 with the liquid filter and the air filter removed;

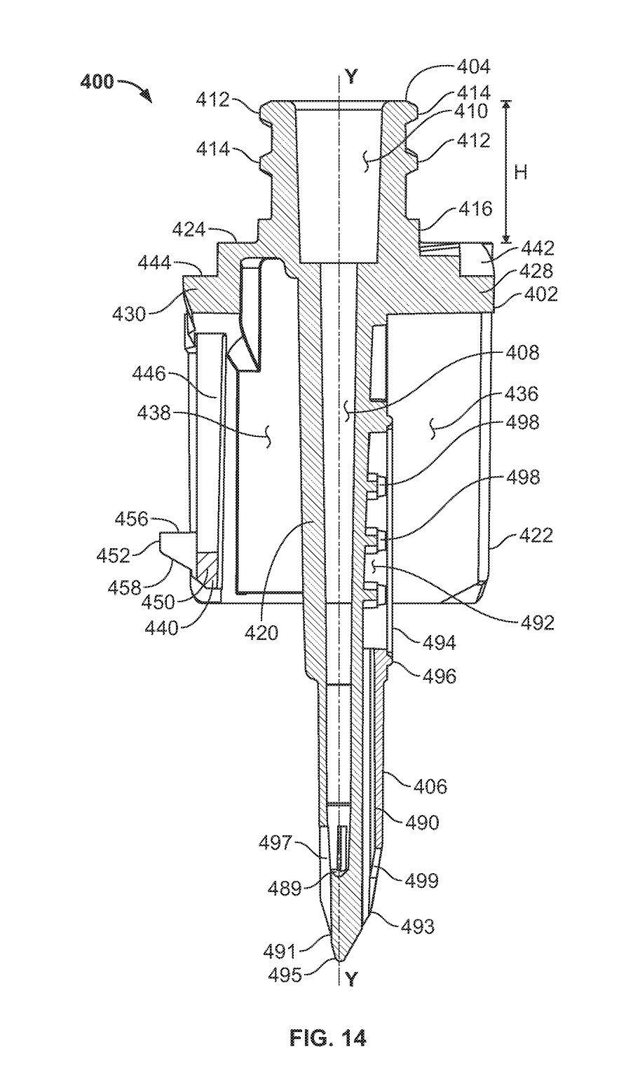

FIG. 14 is a cross-sectional view taken along the plane 14-14 of FIG. 13;

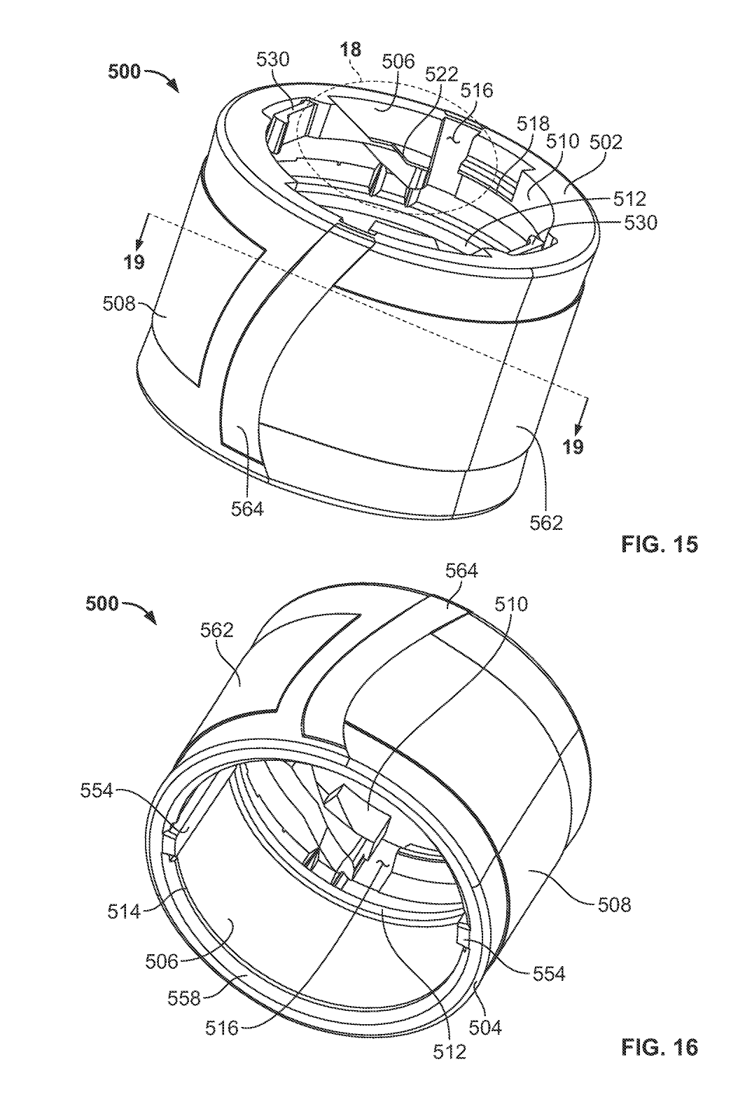

FIG. 15 is a top perspective view of an outer sleeve of the transfer set of FIGS. 1 and 2;

FIG. 16 is a bottom perspective view of the outer sleeve of FIG. 15;

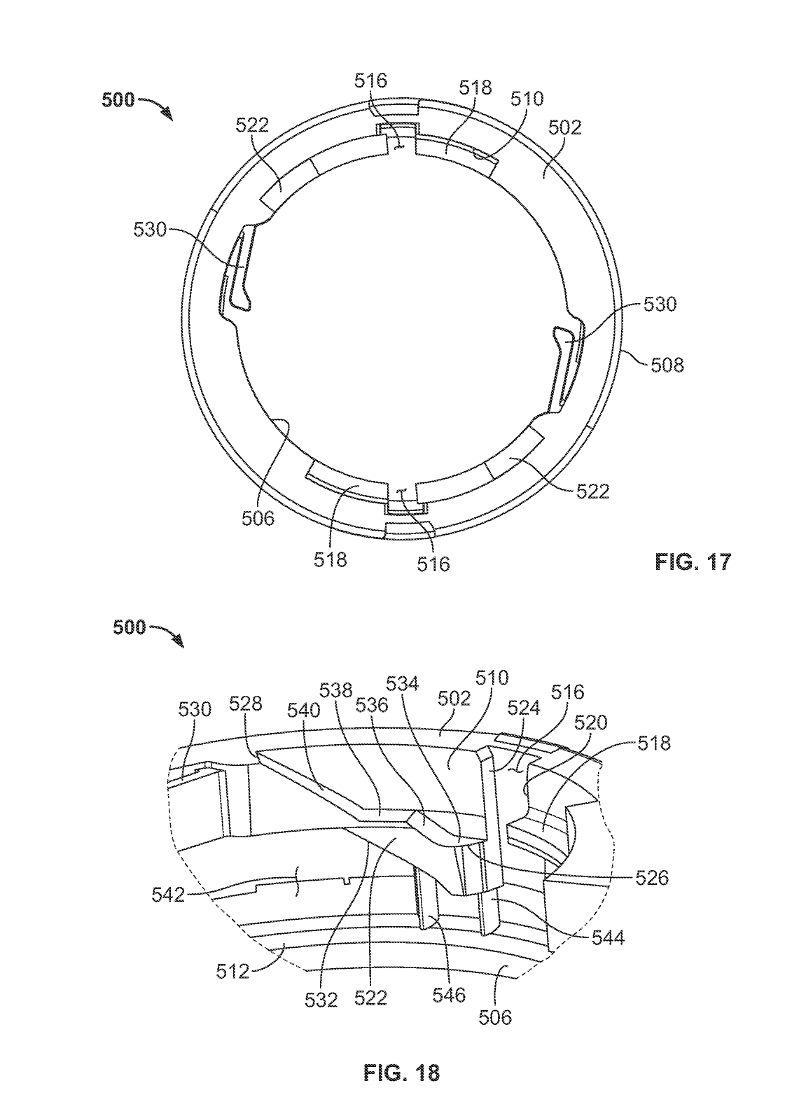

FIG. 17 is a top plan view of the outer sleeve of FIG. 15;

FIG. 18 is an enlarged portion taken within segment 18 of FIG. 15;

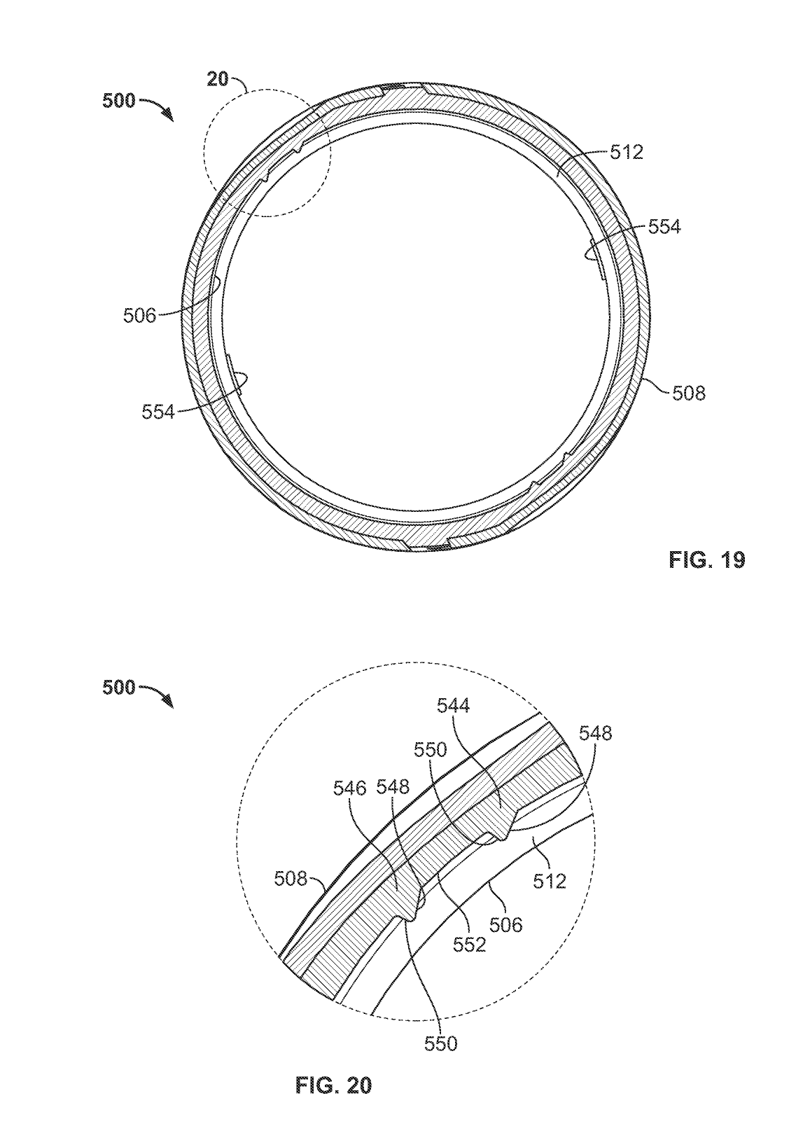

FIG. 19 is a cross-sectional taken along the plane 19-19 of FIG. 15;

FIG. 20 is an enlarged portion of the cross-sectional view of FIG. 19 taken within region 20;

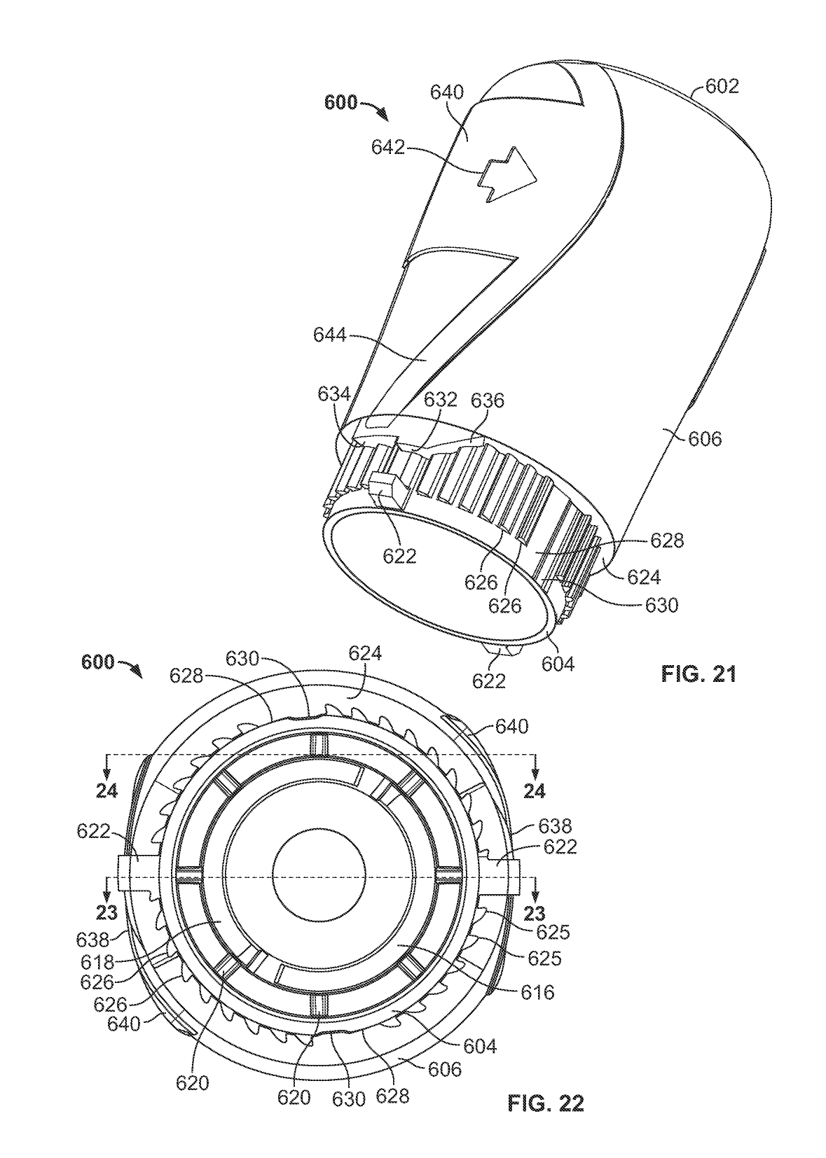

FIG. 21 is a perspective view of a cap of the transfer set of FIGS. 1 and 2;

FIG. 22 is a bottom plan view of the cap of FIG. 21;

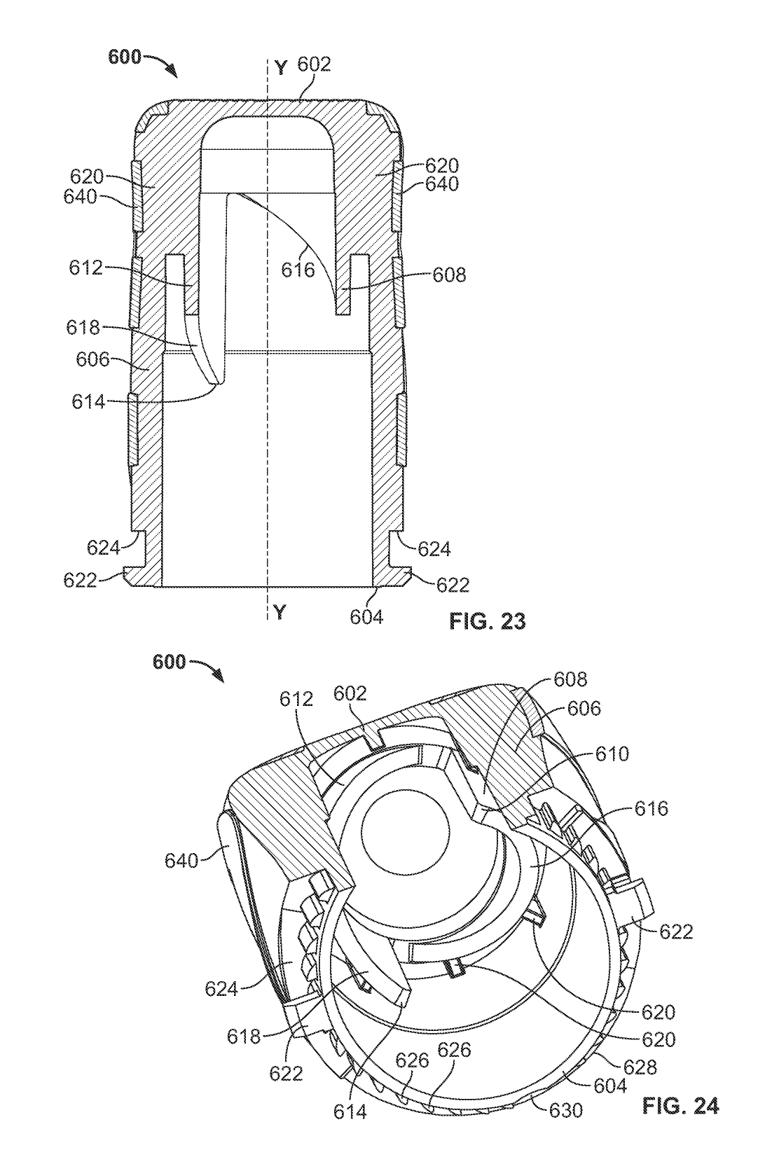

FIG. 23 is a cross-sectional view taken along the plane 23-23 of FIG. 22;

FIG. 24 is another cross-sectional view taken along the plane 24-24 of FIG. 22;

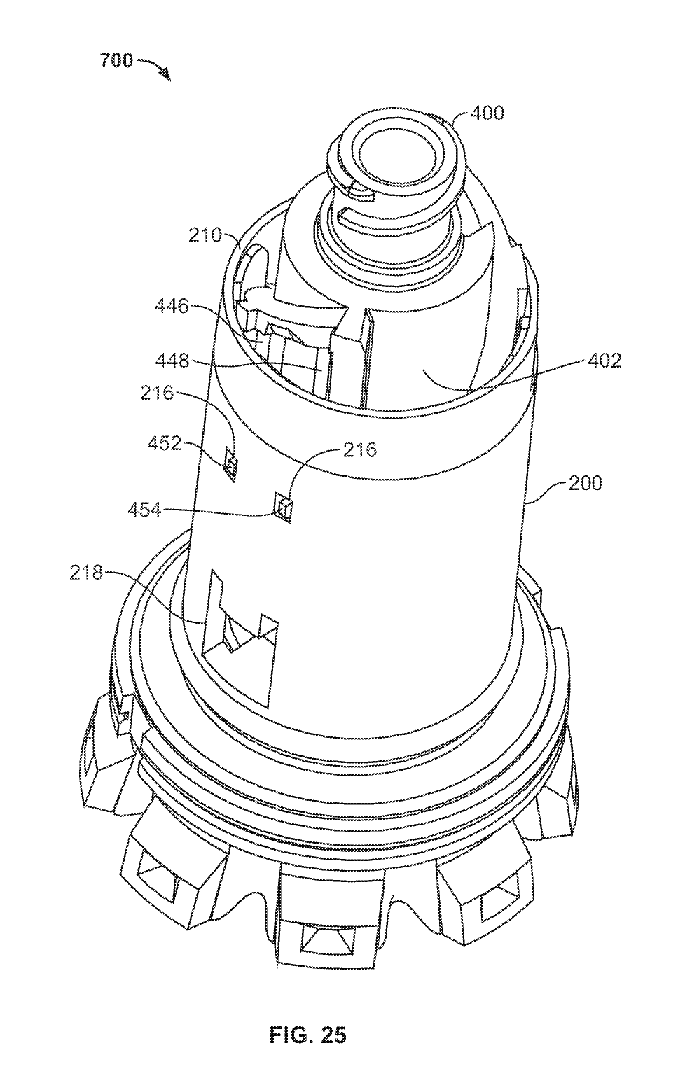

FIG. 25 is a perspective view of the inner sleeve of FIG. 3 and the spike of FIG. 9 in an assembled configuration;

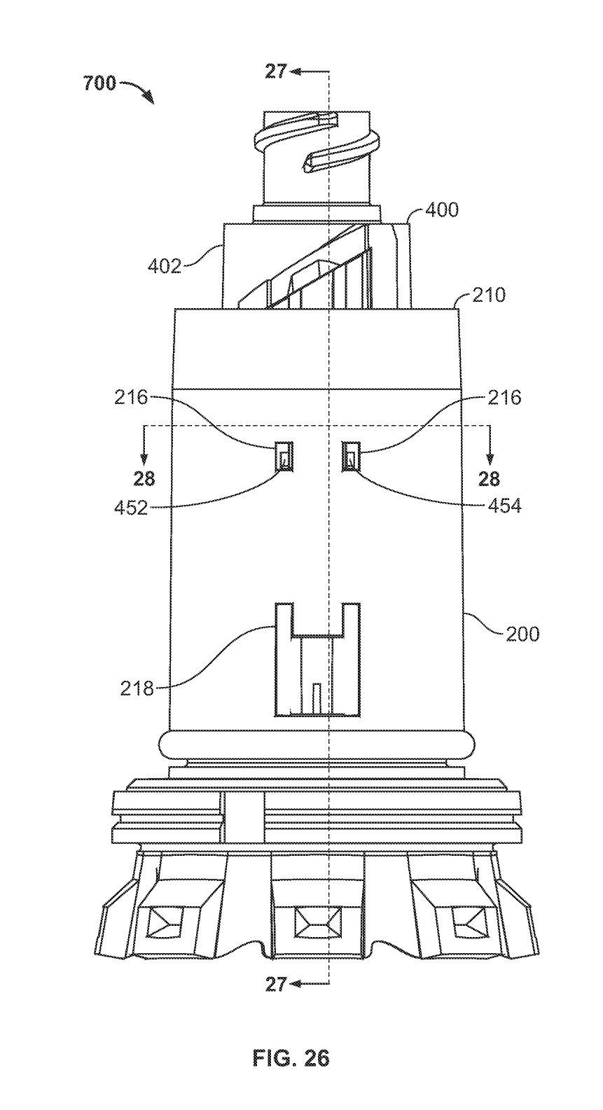

FIG. 26 is a side elevation of the inner sleeve of FIG. 3 and the spike of FIG. 9 in the assembled configuration of FIG. 25;

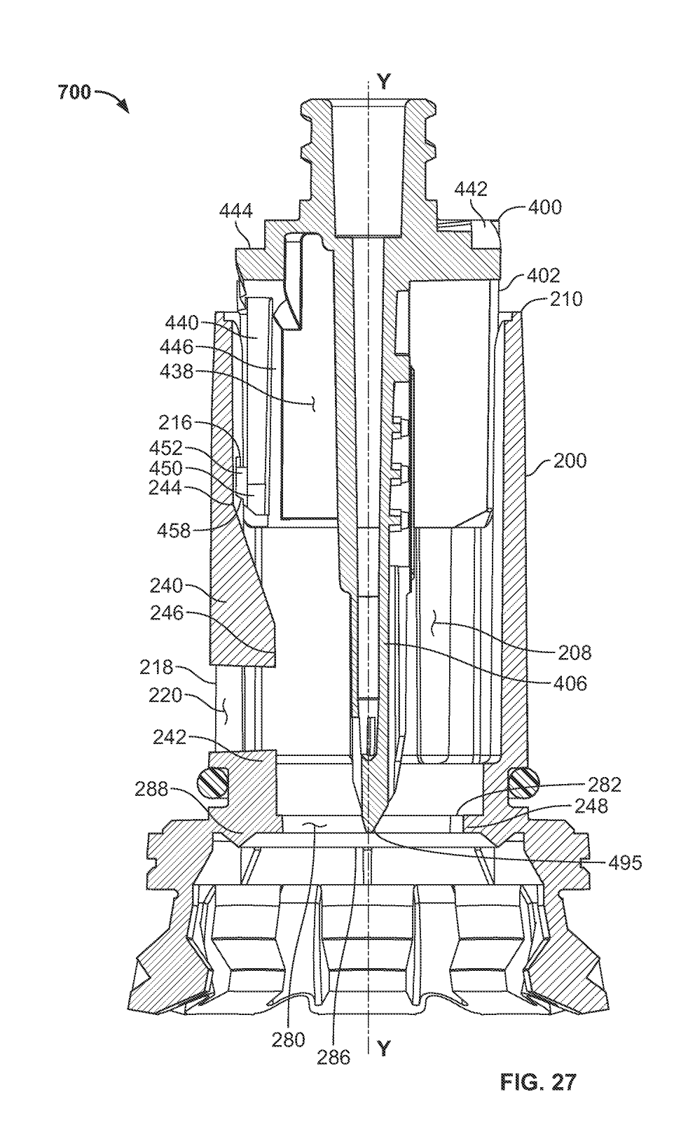

FIG. 27 is a cross-sectional view taken along the plane 27-27 of FIG. 26;

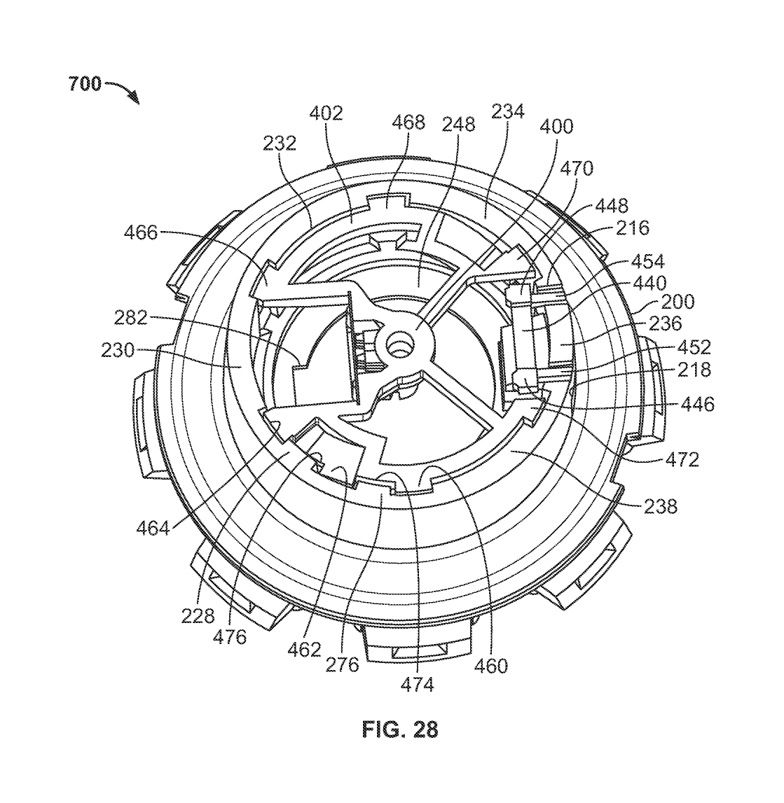

FIG. 28 is a cross-sectional taken along the plane 28-28 of FIG. 26;

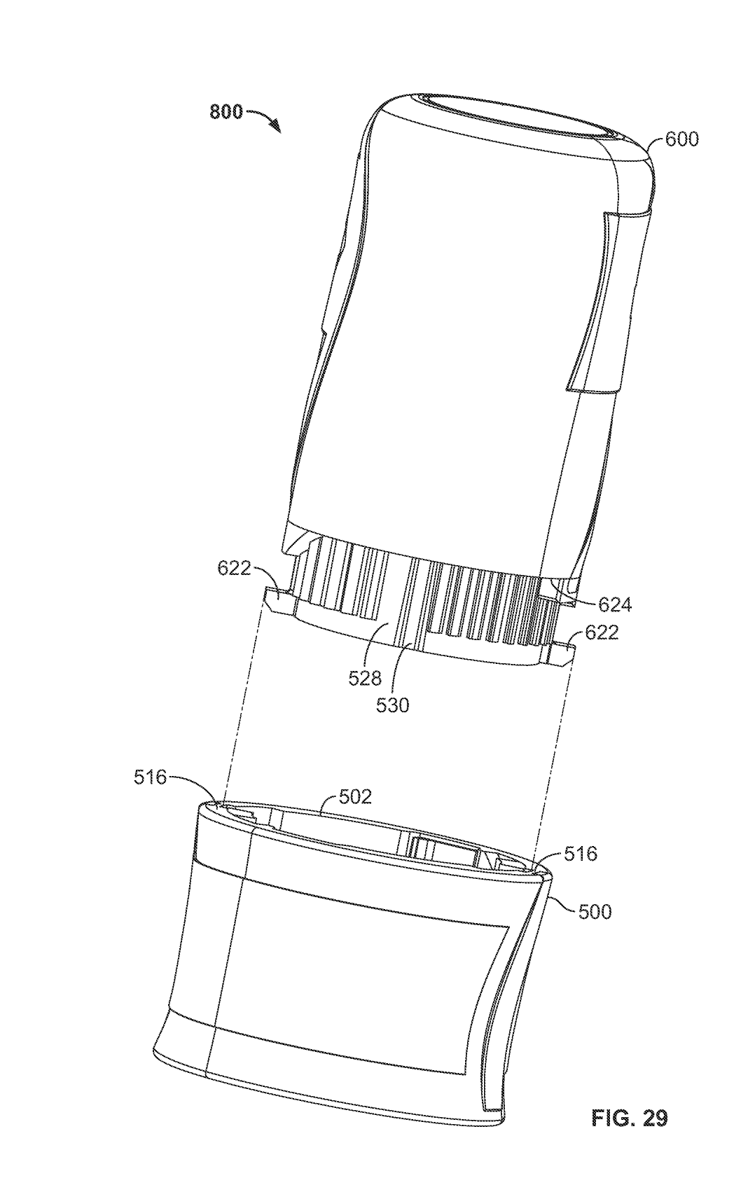

FIG. 29 is a perspective view of the outer sleeve of FIG. 15 and the cap of FIG. 21 during assembly of the transfer set of FIG. 1;

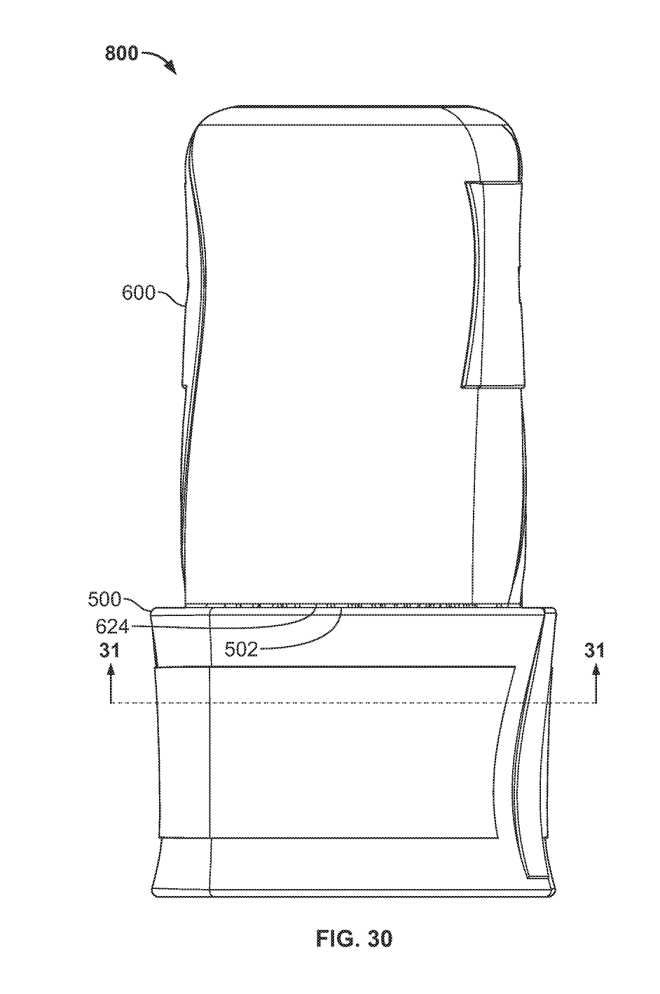

FIG. 30 is a side elevation of the outer sleeve of FIG. 15 and the cap of FIG. 21 in the assembled configuration of FIG. 29;

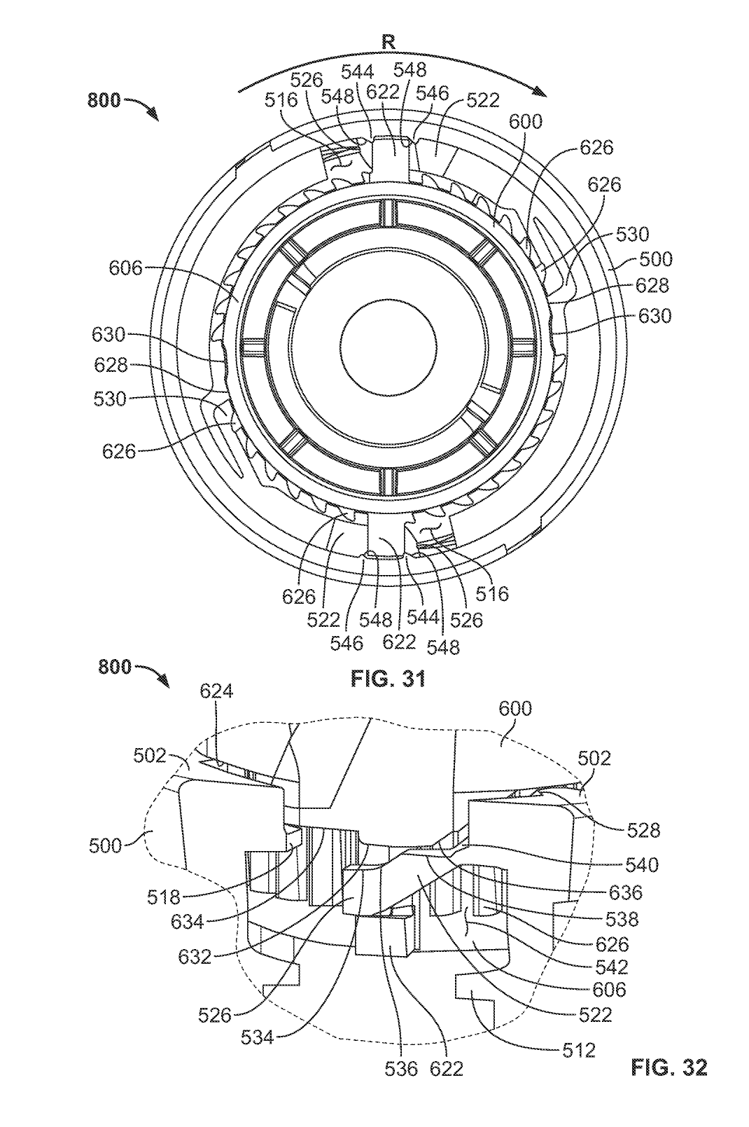

FIG. 31 is a cross-sectional view taken along the plane 31-31 of FIG. 30;

FIG. 32 is an enlarged region of the assembled configuration of FIG. 29;

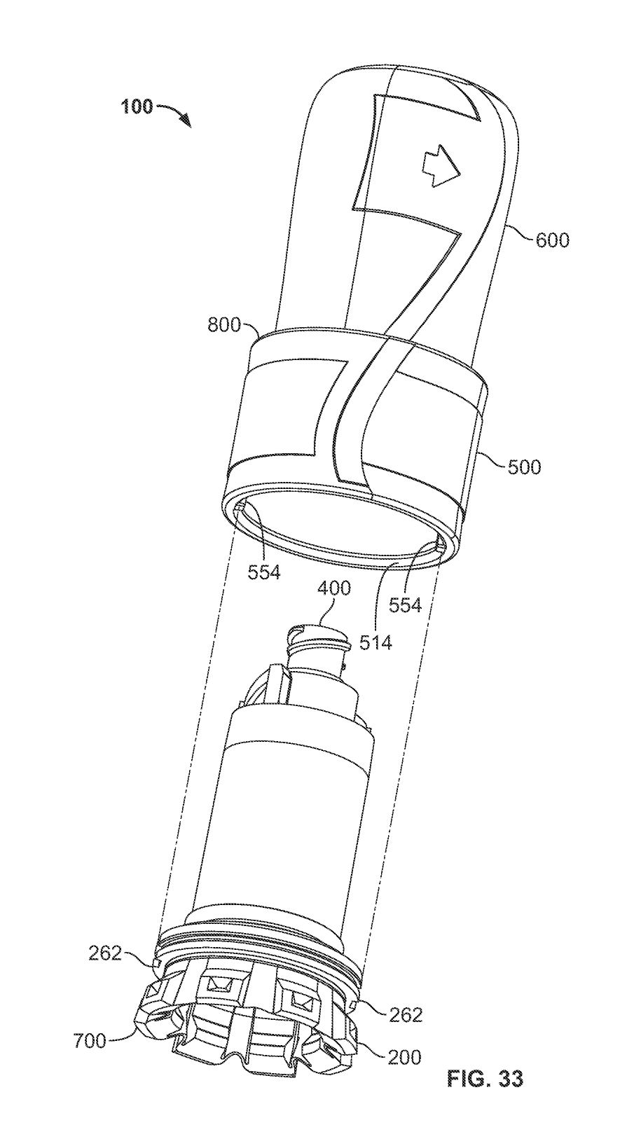

FIG. 33 is a perspective view of the inner sleeve of FIG. 3 and the spike of FIG. 9 (in the assembled configuration of FIG. 25), and the outer sleeve of FIG. 15 and the cap of FIG. 21 (in the assembled configuration of FIG. 29), during assembly of the transfer set of FIG. 1;

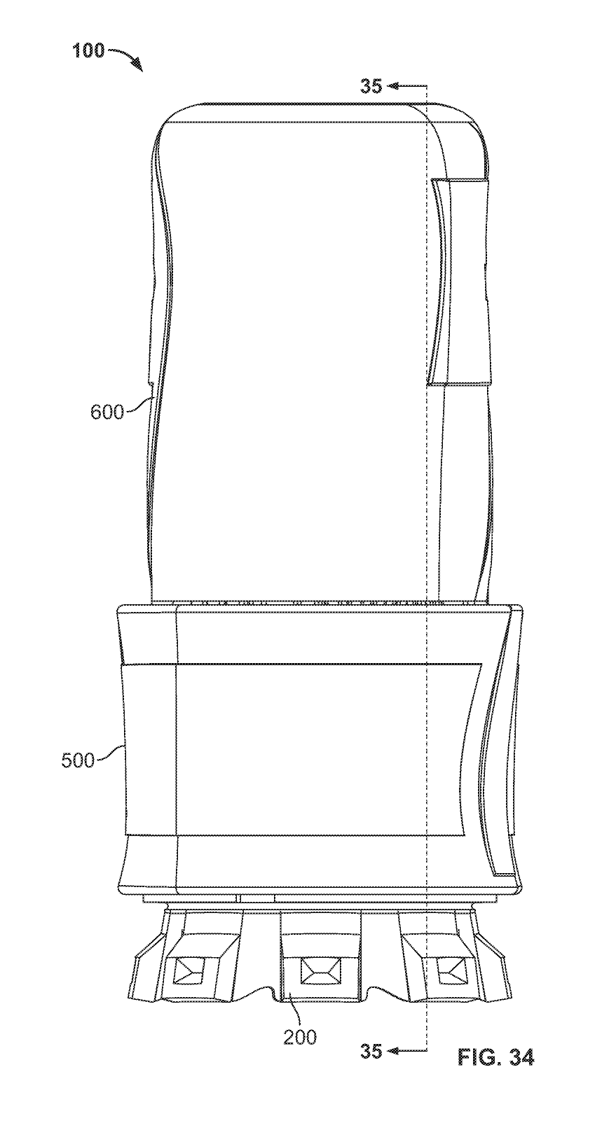

FIG. 34 is a side elevation of the inner sleeve of FIG. 3, the spike of FIG. 9, the outer sleeve of FIG. 15, and the cap of FIG. 21 in the assembled configuration of FIG. 33;

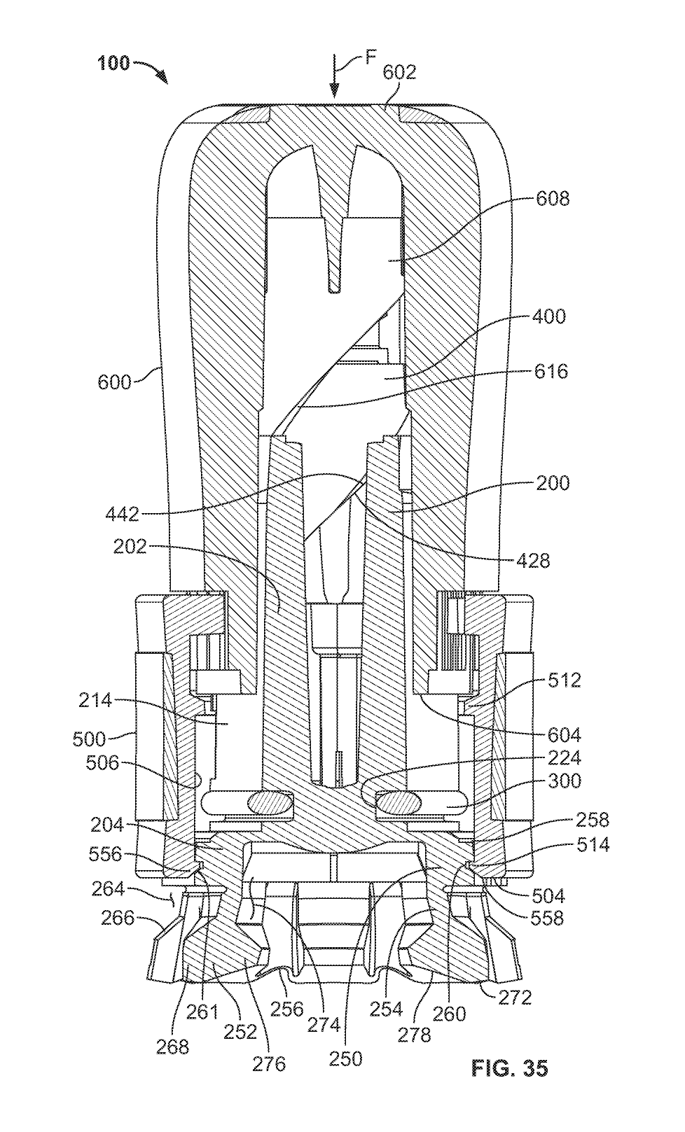

FIG. 35 is a cross-sectional view taken along the plane 35-35 of FIG. 34;

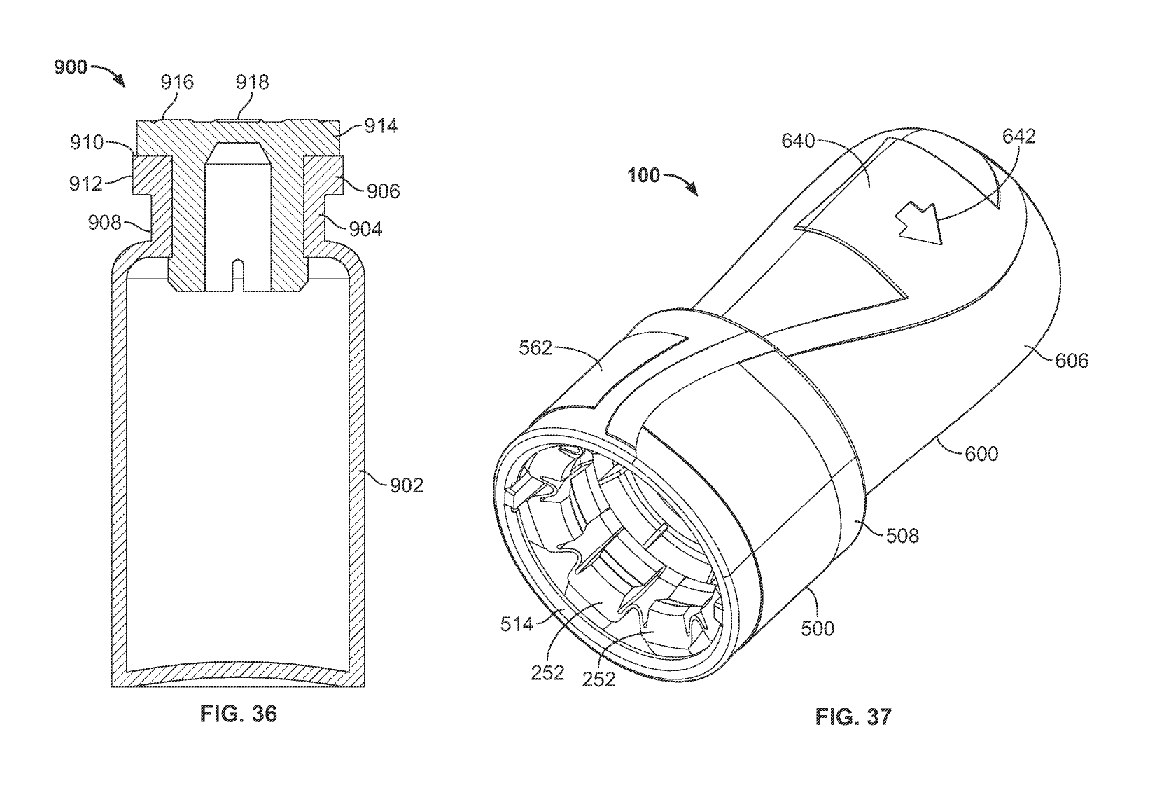

FIG. 36 is a perspective view of a vial on which the transfer set is to be capped; and

FIG. 37 is a bottom perspective view of the transfer set of FIG. 1 in a capped configuration, as if being capped on the vial of FIG. 36.

Corresponding reference characters indicate corresponding parts throughout the several views of the drawings.

### DETAILED DESCRIPTION

Referring now to the drawings, and in particular to FIGS. 1 and 2, a transfer set according to one embodiment is indicated generally by the reference numeral 100. The illustrated transfer set 100 comprises an inner sleeve 200, a gasket 300 (e.g., an O-ring), a spike 400, an outer sleeve 500, and a cap 600 configured for assembly along a longitudinal axis Y (FIG. 2), as described in more detail below. In the illustrated embodiment, the transfer set 100 is configured as a reconstitution device for transferring liquid (e.g., diluent) between a syringe and a sealed vial (e.g., a vial containing a lyophilized medicinal drug). However, it is contemplated that embodiments of the transfer set 100 may be configured for use in transferring liquid between any suitable number of containers housing any suitable substances.

With reference to FIGS. 3-8, the inner sleeve 200 has a tubular upper segment 202 and a tubular lower segment 204. In the illustrated embodiment, the upper segment 202 and the lower segment 204 are integrally formed together to collectively define the monolithic inner sleeve 200. In this manner, a passage 208 (FIG. 4) extends longitudinally through the inner sleeve 200. In other embodiments, the upper segment 202 and the lower segment 204 may be formed separately from, and attached to, one another in any suitable manner.

The illustrated upper segment 202 has an upper end 210, an inner surface 212, and an outer surface 214. An arrangement of apertures extends through the upper segment 202 from the inner surface 212 to the outer surface 214, namely a pair of upper apertures 216 and a lower aperture 218. The lower aperture 218 has a base region 220 and a pair of spaced-apart leg regions 222 extending upward from the base region 220 such that the lower aperture 218 is generally U-shaped. The upper apertures 216 are circumferentially spaced apart from one another, and the lower aperture 218 is spaced longitudinally downward from the upper apertures 216 such that the pair of leg regions 222 are also circumferentially spaced apart, each of the leg regions 222 being in longitudinal alignment with a respective one of the upper apertures 216. Beneath the lower aperture 218, an annular seat 224 is defined by the outer surface 214, and the seat 224 is sized to receive the gasket 300, as set forth in more detail below.

It should be noted that, as used herein, the term “circumferential,” “annular,” or any variation thereof refers to a parameter that extends about the perimeter of an object having any suitable shape (e.g., a square, a rectangle, a triangle, etc.) and is not limited to a parameter that extends about the perimeter of an object having a circular shape. Similarly, as used herein, the term “radial” or any variation thereof refers to a parameter that extends outward from a central region of an object having any suitable shape (e.g., a square, a rectangle, a triangle, etc.) and is not limited to a parameter that extends outward from a central region of an object having a circular shape. Additionally, as used herein, the term “upward,” “upper,” “above,” “top,” or any variation thereof refers to having a relative positioning that is closer to an end point A of the longitudinal axis Y (FIG. 2), and the term “downward,” “lower,” “below,” “beneath,” “underneath,” “bottom,” or any variation thereof refers to having a relative positioning that is closer to an end point B of the longitudinal axis Y (FIG. 2). Moreover, as used herein, the term “inner,” “inward,” “internal,” “interior,” or any variation thereof refers to a relative positioning that is transversely closer to the longitudinal axis Y (FIG. 2), and the term “outer,” “outward,” “external,” “exterior,” or any variation thereof refers to a relative positioning that is transversely farther away from the longitudinal axis Y (FIG. 2).

With reference to FIG. 4, the inner surface 212 of the upper segment 202 defines an arrangement of radially inwardly projecting internal splines extending longitudinally downward from the upper end 210, namely a first internal spline 226, a second internal spline 228, a third internal spline 230, a fourth internal spline 232, a fifth internal spline 234, a sixth internal spline 236, and a seventh internal spline 238 that are sequentially arranged in a circumferentially, substantially equidistantly spaced-apart relationship with one another. The first and second internal splines 226, 228 are narrower than the third, fourth, fifth, sixth, and seventh internal splines 230, 232, 234, 236, 228. Moreover, as seen best in FIG. 3, the inner surface 212 of the upper segment 202 also defines a ramp 240 and a stop 242 that project radially inward. The ramp 240 is aligned circumferentially between, and longitudinally beneath, the upper apertures 216 and extends longitudinally downward toward the lower aperture 218, and the extent to which the ramp 240 projects into the passage 208 becomes progressively greater from a base 244 of the ramp 240 (near the upper apertures 216) to a peak 246 of the ramp 240 (between the leg regions 222 of the lower aperture 218). The stop 242 is aligned longitudinally beneath the peak 246 of the ramp 240 in spaced-apart relation such that the stop 242 projects radially inward into the passage 208 below the ramp 240.

The illustrated lower segment 204 includes (with reference to FIGS. 7 and 8) a radially inwardly projecting bulkhead 248, a radially outwardly projecting flange 250, a plurality of spaced-apart teeth 252 suspended from the flange 250 each by a joint 254, and a plurality of inwardly bent, generally U-shaped webs 256 each connecting a pair of adjacent teeth 252. In this manner, the outer surface 214 of the inner sleeve 212 defines, on the lower segment 204: a substantially annular edge 258 atop the flange 250; a substantially annular notch 260 formed in a periphery of the flange 250, the notch 260 having a lower boundary 261 that is, in part, flat and, in part, sloped; a pair of opposing, longitudinally extending grooves 262 bifurcating the flange 250 through the notch 260; an outer depression 264 corresponding with each joint 254, the outer depression 264 having a sloped lower boundary 266; an outer protuberance 268 on each tooth 252; a recess 270 formed in each outer protuberance 268; and an outer beveled edge 272 beneath each outer protuberance 268.

Similarly, the inner surface 212 of the inner sleeve 200 defines, on the lower segment 204: an inner depression 274 corresponding with each joint 254, opposite the outer depression 264; an inner protuberance 276 on each tooth 252, opposite the outer protuberance 268; and an inner beveled edge 278 beneath each inner protuberance 276. In addition, the illustrated bulkhead 248 is annular and extends radially inward into the passage 208, thereby creating a neck 280 (or narrowed portion) of the passage 208. The bulkhead 248 has a cutout 282, an upper surface 284 and a lower surface 286, the lower surface 286 defining an annular prong 288.

Now referring to FIGS. 9-14, the illustrated spike 400 is sized for insertion into the upper segment 202 of the inner sleeve 200, as set forth in more detail below. The spike 400 includes a body segment 402, a connector segment 404 extending upward from the body segment 402, and a tip segment 406 extending downward from the body segment 402. In the illustrated embodiment, the body segment 402, the connector segment 404, and the tip segment 406 are integrally formed together to collectively define the monolithic spike 400. In this manner, a conduit 408 (FIG. 14) extends through the spike 400 from the connector segment 404 to the tip segment 406 along the longitudinal axis Y (FIG. 2). In other embodiments, the body segment 402, the connector segment 404, and the tip segment 406 may be formed separately from, and attached to, one another in any suitable manner.

Still referring to FIG. 14, the connector segment 404 is a tubular structure that provides, on the inside, a tapered female fitting 410 which defines an upper section of the conduit 408, and, on the outside, an arrangement of threads, namely a first thread 412 and a second thread 414 that are arranged opposite one another. In this manner, the connector segment 404 is configured for a luer-type (e.g., luer lock) connection with a syringe or other suitable container. Notably, the connector segment 404 has an annular, thickened interface 416 at the body segment 402, and the connector segment 404 has a height H (measured upward from the interface between the body segment 402 and the connector segment 404). Each thread 412, 414 is a partial (or semi-annular) thread that extends around only a portion (e.g., only substantially half) of the circumference of the connector segment 404 (not the entire circumference), thereby spanning only substantially half of the height of the connector segment 404 (not the entire height H). Additionally, a liquid filter 418 (FIG. 11) is attached to the body segment 402 at the bottom of the female fitting 410 such that the liquid filter 418 extends across the conduit 408 to inhibit particulate matter from passing downward in the conduit 408 beyond the connector segment 404.

The illustrated body segment 402 (with reference to FIGS. 9 and 14) includes an inner body 420 and an outer body 422, the outer body 422 being joined with the inner body 420 via an upper wall 424 (from which the thickened interface 416 of the connector segment 404 extends upward) and a plurality of radial ribs 426, the outer body 422 thereby acting as a shell that partially surrounds the inner body 420 to render the body segment 402 substantially hollow between the inner and outer bodies 420, 422. In other embodiments, the body segment 402 may be configured in any suitable manner that facilitates enabling the spike 400 to function as described herein.

As seen in FIG. 9, the illustrated outer body 422 has: a radially outwardly projecting follower arrangement, namely a first follower 428 and a second follower 430; a mold-release 432 (FIG. 11) radially inward of, and adjacent to, the first follower 428; a shoulder 434 radially between the first follower 428 and the mold-release 432; a first alcove 436 (FIG. 10) situated beneath the first follower 428; a second alcove 438 (FIG. 14) situated beneath the second follower 430; and a clip 440 (FIG. 9) suspended within the second alcove 438. As illustrated in FIGS. 9 and 10, the first follower 428 has a first follower surface 442 that is sloped (e.g, generally helically sloped), and the second follower 430 has a second follower surface 444 that is sloped (e.g., generally helically sloped), the second follower surface 444 being opposite the first follower surface 442 (e.g., the first follower surface 442 and the second follower surface 444 are sloped in a generally double-helical manner). The shoulder 434 (FIG. 11) separates the first follower surface 442 from the mold-release 432.

Referring back to FIG. 9, the clip 440 includes, in a U-shaped or stirrup-shaped arrangement: a first flexible (or resilient) suspension member (e.g., a first leg 446) extending downward into the second alcove 438; a second flexible (or resilient) suspension member (e.g., a second leg 448) extending downward into the second alcove 438 opposite the first leg 446; a retention member (i.e., a crossbar 450) extending across the second alcove 438 from the first leg 446 to the second leg 448; a first catch 452 extending outward from the junction of the first leg 446 and the crossbar 450; and a second catch 454 extending outward from the junction of the second leg 448 and the crossbar 450. Each catch 452, 454 has an upper surface 456 that is oriented substantially perpendicular to the longitudinal axis Y, and a lower surface 458 that is oriented oblique (i.e., sloped) to the longitudinal axis Y (FIG. 14).

The outer body 422, as seen best in FIG. 12, also includes an arrangement of radially outwardly projecting external splines extending longitudinally downward from the follower surfaces 442, 444, namely a first external spline 460, a second external spline 462, a third external spline 464, a fourth external spline 466, a fifth external spline 468, a sixth external spline 470, and a seventh external spline 472 sequentially arranged in a circumferentially spaced-apart relationship with one another. A first space 474 separates the first external spline 460 from the second external spline 462 and corresponds to the size of the first internal spline 226; a second space 476 separates the second external spline 462 from the third external spline 464 and corresponds to the size of the second internal spline 228; a third space 478 separates the third external spline 464 from the fourth external spline 466 and corresponds to the size of the third internal spline 230; a fourth space 480 separates the fourth external spline 466 from the fifth external spline 468 and corresponds to the size of the fourth internal spline 232; a fifth space 482 separates the fifth external spline 468 from the sixth external spline 470 and corresponds to the size of the fifth internal spline 234; a sixth space 484 separates the sixth external spline 470 from the seventh external spline 472 and corresponds to the size of the sixth internal spline 236; and a seventh space 486 separates the seventh external spline 472 from the first external spline 460 and corresponds to the size of the seventh internal spline 238.

In the embodiment of FIG. 14, the inner body 420 and the tip segment 406 define intermediate and lower sections of the conduit 408, respectively, as well as collectively defining an airflow path 490 leading from the tip segment 406 to an air vent 492 formed on an exterior of the inner body 420 within the first alcove 436 (FIG. 14). The vent 492 is covered by a hydrophobic air filter 494 (FIG. 11) that is ultrasonically welded to the exterior of the inner body 420 about a periphery of the vent 492 (via an annular bead 496) and is supported centrally by a plurality of studs 498 (or spacers) formed integrally with the inner body 420 and disposed within the vent 492. A series of elongate ports 497 are provided near a distal end 495 of the tip segment 406 in fluid communication with the conduit 408, and the tip segment 406 has a concave (or generally cup-shaped) bounding surface 489 that defines the lower end of the conduit 408, the bounding surface 489 enabling liquid to be discharged from the ports 497 in a direction that is substantially perpendicular to the longitudinal axis Y, as set forth in more detail below.

Also provided near the distal end 495 of the tip segment 406 is an inlet 499 to the airflow path 490. Notably, the inlet 499 is scalloped, and the open bottom 493 of the inlet 499 is spaced farther upward from the distal end 495 of the tip segment 406 than the open bottoms 491 of the ports 497, thereby inhibiting liquid entry into the airflow path 490 through the inlet 499, as set forth in more detail below. Moreover, during manufacture of the spike 400, the spike 400 may be dropped onto a conveyor belt after removal from the mold, and impact of the spike 400 with the conveyor belt at the distal end 495 of the tip segment 406 (e.g., while warm after a molding operation) could cause the distal end 495 to bend, which is undesirable. However, because the distal end 495 is blunted, bending of the distal end 495 upon impact of the tip segment 406 with another object is inhibited.

With reference now to FIGS. 15-20, the illustrated outer sleeve 500 is tubular and is sized to receive part of the inner sleeve 200 as set forth in more detail below. The outer sleeve 500 has a top surface 502, a bottom surface 504, an inner surface 506, and an outer surface 508. Defined by the inner surface 506 of the outer sleeve 500 are a rim 510, an upper lip 512, and a lower lip 514. The rim 510 is bifurcated by a pair of opposed slots 516 and includes (with reference to FIG. 18): a relatively flat ledge 518 offset radially inward of, and longitudinally downward from, the top surface 502 adjacent a first side 520 of each slot 516; an inclined ledge 522 offset radially inward of, and longitudinally downward from, the top surface 502 adjacent an opposing second side 524 of each slot 516, the inclined ledge 522 having a base 526 that acts as a threshold into the slot 516 and a peak 528 that acts as a threshold onto the top surface 502; and a pawl 530 (e.g., a flexible finger) offset radially inward of, and longitudinally downward from, the top surface 502, circumferentially ahead of the peak 528 of the inclined ledge 522. In the illustrated embodiment, the inclined ledge 522 has a sloped underside 532 and a stepped topside, the topside including, in sequential order from the base 526 to the peak 528: a first step 534; a first slope 536; a second step 538; and a second slope 540.

The upper lip 512 is annular and is spaced beneath the rim 510 such that a substantially annular channel 542 is provided between the rim 510 and the upper lip 512, the only longitudinal ingress to, or egress from, the channel 542 being via the slots 516. Notably, the channel 542 is interrupted by two circumferentially spaced-apart ridges that extend longitudinally between the upper lip 512 and the rim 510, namely a first ridge 544 disposed beneath the first step 534 of the inclined ledge 522, and a second ridge 546 disposed beneath the second step 538 of the inclined ledge 522.

As seen in FIG. 20, each of the ridges 544, 546 has a generally triangular profile with a first side 548 (facing toward the nearby slot 516) and a second side 550 (facing away from the nearby slot 516), the profile being asymmetrical such that the second side 550 is more steeply inclined than the first side 548 (e.g., the second side 550 is nearly perpendicular to an inner face 552 of the upper lip 512). Spaced beneath the upper lip 512 is the lower lip 514 (FIG. 16), which is adjacent the bottom surface 504 of the outer sleeve 500. The lower lip 514 is bifurcated by a pair of opposing tongues 554 that extend downward from the upper lip 512 through the lower lip 514, and the lower lip 514 has an inner face (not shown) and a beveled surface 558 extending from the inner face to the bottom surface 504 (FIG. 16).

The outer surface 508 (or exterior) defines a pair of annularly isolated (i.e., not annularly continuous), indented (or flattened) gripping areas 560 that are substantially diametrically opposed and are formed at least in part by a substantially annular, resilient polymeric gripping ring 562 (FIG. 16) (i.e., the outer sleeve profile, as the profile extends from the top surface 502 to the bottom surface 504, is indented (or flattened) in a manner that is not continuous about the entire circumference of the outer sleeve 500). As such, the outer sleeve 500 has an oblong (or non-circular) cross-sectional contour, taken through a middle region of the outer sleeve 500 (FIG. 19). In the illustrated embodiment, the gripping ring 562 is divided by a pair of opposing visual alignment markers, each being in the form of a swept guideline 564 (FIG. 16) that extends along the outer surface 508 substantially from the top surface 502 to the bottom surface 504. In other suitable embodiments, the indented (or flattened) contour of the outer surface 508 (as it extends from the top surface 502 to the bottom surface 504) may be annularly continuous (i.e., not annularly isolated) about the entire outer sleeve 500, or the outer sleeve 500 may not have indented or flattened areas. Moreover, the outer surface 508 may be provided with any suitable visual alignment marker(s) arranged in any suitable manner.

Referring to FIGS. 21-24, the illustrated cap 600 is sized to receive the upper segment 202 of the inner sleeve 200 of FIGS. 3-8 and to fit in part within the outer sleeve 500, as set forth in more detail below. The cap 600 is generally cup-shaped and includes a closed top wall 602, an annular bottom edge 604 (circumscribing an open bottom of the cap), and an annular side wall 606 extending from the closed top wall 602 to the bottom edge 604. As best seen in FIG. 23, formed integrally with, and extending longitudinally downward from an undersurface of the closed top wall 602 within the interior of the cap 600 (in spaced-apart relation with the side wall 606) is a cam arrangement, namely a first cam 608 having a first tip 610 and a second cam 612 having a second tip 614. The first cam 608 has a sloped (e.g, generally helically sloped) first cam surface 616, and the second cam 612 has a sloped (e.g., generally helically sloped) second cam surface 618 opposite the first cam surface 616 (e.g., the first cam surface 616 and the second cam surface 618 are sloped in a generally double-helical manner that generally mirrors the generally double-helical manner in which the first and second follower surfaces 442, 444 of FIGS. 9 and 10 are sloped). The cams 608, 612 are supported in their longitudinally downward extension from the closed top wall 602, and in their spaced-apart relation with the side wall 606, via a plurality of circumferentially spaced support ribs 620 extending from the side wall 606 to the cams 608, 612.

Referring back to FIG. 21, formed on an exterior of the cap 600 are: a pair of tabs 622 disposed on opposite sides of the cap 600 adjacent the bottom edge 604; an annular overhang surface 624 spaced above the bottom edge 604; and a plurality of ratchet-type teeth 626 (e.g., asymmetrical teeth having one side that is more steeply inclined than the other side) that are spaced circumferentially about the cap 600 between the bottom edge 604 and the overhang surface 624, the teeth 626 being arranged in a pair of opposing sets that are separated by a pair of opposing gaps 628 through each of which a crease 630 extends from the overhang surface 624 to the bottom edge 604. As seen in FIG. 32, above each tab 622 is a formation of guide surfaces extending downward from the overhang surface 624, the formation of guide surfaces including: a first flat surface 632 aligned above a respective one of the tabs 622; a second flat surface 634 adjacent one side of the first flat surface 632 and offset longitudinally upward from the first flat surface 632; and a sloped surface 636 adjacent the opposing side of the first flat surface 632 and extending from the first flat surface 632 to the overhang surface 624, thereby blending smoothly with the first flat surface 632 and the overhang surface 624.

Also formed on the exterior of the cap 600 are a pair of annularly isolated (i.e., not annularly continuous), indented (or flattened) gripping areas 638 (FIG. 22) that are substantially diametrically opposed and are formed at least in part by a pair of opposing polymeric gripping surfaces 640 (FIG. 22) (i.e., the cap profile, as the profile extends from the closed top wall 602 to the bottom edge 604, is indented (or flattened) in a manner that is not continuous about the entire circumference of the cap 600). As such, the cap 600 has an oblong (or non-circular) exterior contour when the cap 600 is viewed from the bottom as seen in FIG. 22. Each of the gripping surfaces 640 includes a rotation-direction indicator (e.g., an arrow 642 as seen in FIG. 21) and is flanked (in the direction indicated by the arrow 642) by a visual alignment marker in the form of a swept guideline 644 that extends substantially from the closed top wall 602 to the overhang surface 624. In other suitable embodiments, the indented (or flattened) cap profile (as the profile extends from the closed top wall 602 to the bottom edge 604) may be annularly continuous about the entire cap 600, or the cap 600 may not have indented or flattened areas. Moreover, the cap 600 may be provided with any suitable visual alignment marker(s) or rotation-direction indicator(s) arranged in any suitable manner.

Referring now to FIGS. 25-35, to assemble the transfer set 100, the spike 400 and the inner sleeve 200 are connected together as shown in FIG. 25 to form a first assembled (or conjoint) unit 700 (FIGS. 25-28), and the outer sleeve 500 and the cap 600 are connected together as shown in FIGS. 29 and 30 to form a second assembled (or conjoint) unit 800 (FIGS. 29-32). As set forth in more detail below, the first assembled unit 700 and the second assembled unit 800 are then connected together as illustrated in FIG. 33 to form the assembled transfer set 100 (FIGS. 1 and 34-35). Notably, the first assembled unit 700 may be formed before, after, or simultaneous with the formation of the second assembled unit 800.

With particular reference to FIGS. 25-28, the first assembled unit 700 is formed by aligning the first and second internal splines 226, 228 of the inner sleeve 200 with the first and second spaces 474, 476 of the spike 400 and then inserting the spike 400 into the passage 208 of the inner sleeve 200 such that the internal splines 226, 228, 230, 232, 234, 236, 238 of the inner sleeve 200 mate with the external splines 460, 462, 464, 466, 468, 470, 472 of the spike 400. Because the spike 400 must have a particular orientation relative to the inner sleeve 200 (i.e., the clip 440 must be circumferentially aligned with the apertures 216, 218), the cutout 282 in the bulkhead 248 of the inner sleeve 200 functions as an alignment feature for properly orienting the inner sleeve 200 on the tooling (e.g., the jigs or fixtures) during assembly of the transfer set 100 described below, and the narrower internal splines 226, 228 of the inner sleeve 200 (as well as the more closely spaced external splines 460, 462, 464) of the spike 400 function as keying features for properly inserting the spike 400 into the inner sleeve 200 (i.e., enabling insertion of the spike 400 into the inner sleeve 200 only if the spike 400 is oriented in a specific circumferential position relative to the inner sleeve 200). The cutout 282 and the narrower internal splines 226, 228 of the inner sleeve 200, therefore, facilitate better repeatability and less waste caused by improperly inserted spikes 400 during assembly.

Because the catches 452, 454 of the clip 440 protrude radially outward beyond the external contour of the external splines 460, 462, 464, 466, 468, 470, 472 of the spike 400 (FIG. 14), the catches 452, 454 are sized to contact the upper end 210 of the inner sleeve 200 as the body segment 402 of the spike 400 enters the passage 208. When the lower surfaces 458 of the catches 452, 454 contact the upper end 210 of the inner sleeve 200, the legs 446, 448 of the clip 440 flex (or bend) radially inward into the second alcove 438 due to the lower surfaces 458 being oblique to the longitudinal axis Y. In this manner, the clip 440 is essentially spring-loaded as a result of the catches 452, 454 traversing the upper end 210 of the inner sleeve 200. When the catches 452, 454 encounter the upper apertures 216 of the inner sleeve 200, the clip 440 is permitted to snap outward, thereby releasing potential energy associated with its spring-loaded state, each catch 452, 454 entering a respective one of the upper apertures 216.

The catches 452, 454 thereby retain the spike 400 in a first fixed position (FIG. 27) within the inner sleeve 200, the spike 400 and the inner sleeve 200 collectively forming the first assembled unit 700 (FIGS. 25-28). Notably, on the first assembled unit 700, the distal end 495 of the tip segment 406 of the spike 400 is disposed within the neck 280 of the passage 208 but does not extend beyond the lower surface 286 of the bulkhead 248 (FIG. 40). As such, the first assembled unit 700 can be stored or transported (i.e., the spike 400 and the inner sleeve 200 can be stored or transported conjointly) with the spike 400 being retained in the first fixed position (FIG. 27) within the inner sleeve 200.

With particular reference now to FIGS. 29-32, the second assembled unit 800 is formed by aligning the tabs 622 of the cap 600 with the slots 516 of the outer sleeve 500 and then inserting the cap 600 into the outer sleeve 500 (FIG. 29) such that the tabs 622 enter the slots 516 and the overhang surface 624 of the cap 600 contacts, or is closely spaced from, the top surface 502 of the outer sleeve 500. Each of the guide formations (FIG. 32) on the cap 600 (i.e., the first flat surface 632, the second flat surface 634, and the sloped surface 636) thereby mates with the corresponding flat and inclined ledges 518, 522 of the outer sleeve 500. More specifically, each of the guide formations mates with a respective one pair of flat and inclined ledges 518, 522 such that: the second flat surface 634 of the guide formation is seated on, or closely spaced from, the flat ledge 518; the first flat surface 632 of the guide formation is seated on, or closely spaced from, the first step 534 of the inclined ledge 522; and the sloped surface 636 of the guide formation is seated on, or closely spaced from, the first slope 536 of the inclined ledge 522. Accordingly, each tab 622 of the cap 600 (having passed through its respective slot 516 of the outer sleeve 500 and being disposed above the upper lip 512 of the outer sleeve 500) is located longitudinally downward from, and circumferentially adjacent to, the base 526 of its respective inclined ledge 522 of the outer sleeve 500. Moreover, after the tabs 622 have been inserted into the slots 516, each pawl 530 is disposed within a respective one of the opposed creases 630 of the cap 600, thereby contacting, or being in closely spaced relation to, the side wall 606 of the cap 600.

After insertion of the cap 600 into the outer sleeve 500, the cap 600 is then manually rotated relative to the outer sleeve 500 (in a counterclockwise direction when the cap is viewed from above or, in other words, a clockwise direction R when the outer sleeve 500 is viewed from below as in FIG. 31). As the cap 600 rotates, each tab 622 passes underneath the base 526 of the nearby inclined ledge 522 of the outer sleeve 500 to enter the channel 542 of the outer sleeve 500, and each tab 622 thereafter traverses the first side 548 of the corresponding first ridge 544, thereby being positioned longitudinally beneath the nearby base 526 and circumferentially between the corresponding first ridge 544 and its associated second ridge 546.

Simultaneous to each tab 622 passing underneath the base 526 of the nearby inclined ledge 522, the sloped surface 636 of each guide formation of the cap 600 contacts the first slope 536 of the respective inclined ledge 522, thereby driving the cap 600 upward (i.e., lifting the first flat surface 632 and the second flat surface 634 of the guide formation off of, or farther away from, the first step 534 and the flat ledge 518, respectively, as shown in FIG. 32). After the tabs 622 traverse the first ridges 544, the tabs 622 encounter the first sides 548 of the second ridges 546, and resistance to continued rotation can be felt by the user, at which time rotation is to cease such that each of the tabs 622 remains disposed circumferentially between its corresponding ridges 544, 546 and longitudinally beneath its corresponding base 526, with the first flat surface 632 of each guide formation being seated on, or closely spaced from, the second step 538 of the corresponding inclined ledge 522 (the guideline 564 of the outer sleeve 500 being aligned with the guideline 644 of the cap to provide a visual indication to the user that each of the tabs 622 is properly located between its corresponding ridges 544, 546). In such a position, rotation of the cap 600 (in either direction) is inhibited, due in part to the tabs 622 being located between the ridges 544, 546 (i.e., rotation of the tabs 622 is obstructed by the ridges 544, 546). Moreover, longitudinal displacement of the cap 600 relative to the outer sleeve 500 is also inhibited, due in part to the tabs 622 being located beneath the bases 526 of the inclined ledges 522 (FIGS. 31 and 32).

Notably, as the cap 600 is rotated after insertion of the tabs 622 through the slots 516, each pawl 530 traverses its respective crease 630 of the cap 600 by flexing radially outward to slide along the associated gap 628 in contact with the side wall 606 of the cap 600 between the opposed sets of teeth 626. As such, upon traversing its corresponding crease 630, each pawl 530 is essentially spring-loaded. As the pawls 530 continue to slide along their respective gaps 628 toward the teeth 626, each pawl encounters (e.g., contacts but does not traverse) the first tooth 626 of its respective set (FIG. 31).

Connected together in such an arrangement, the cap 600 and the outer sleeve 500 collectively define the second assembled unit 800 (FIGS. 29-32). The second assembled unit 800 can thereafter be stored or transported (i.e., the cap 600 and the outer sleeve 500 can be stored or transported conjointly) with the cap 600 being retained within the outer sleeve 500.

Referring particularly to FIGS. 33-35, after the first assembled unit 700 (i.e., the conjoint inner sleeve 200 and spike 400) and the second assembled unit 800 (i.e., the conjoint outer sleeve 500 and cap 600) are formed separately from one another as described above, the second assembled unit 800 is then connected to the first assembled unit 700 by aligning the tongues 554 of the outer sleeve 500 with the grooves 262 of the inner sleeve 200 and inserting the inner sleeve 200 (and the spike 400) into the outer sleeve 500 (and the cap 600), the tongues 554 and the grooves 262 being in mating relation (FIG. 33).

Because improper alignment of the cap 600 with the inner sleeve 200 during assembly of the transfer set 100 can cause damage to the cams 608, 612 (or other features) and can prevent proper assembly of the transfer set 100, the outer sleeve 500 is relied upon for properly orienting the cap 600 relative to the spike 400. Specifically, the tongues 554 and the grooves 262 act as keying features that align the spike 400 and the cap 600 during assembly of the transfer set 100, enabling self-alignment of the cams 608, 612 of the cap 600 with the followers 428, 430 of the spike 400 to facilitate better repeatability and less waste caused by damaged cams 608, 612 that result from improper mating of the cams 608, 612 with the followers 428, 430.

As the tongues 554 enter the grooves 262, the lower lip 514 of the outer sleeve 500 contacts the flange 250 of the inner sleeve 200 at the edge 258, and the beveled surface 558 of the lower lip 514 slides downward along the edge 258 of the flange 250 to expand (or flex) the outer sleeve 500 radially outward. After traversing the edge 258 of the flange 250, the outer sleeve 500 clamps against the flange 250 such that the inner face 556 of the lower lip 514 exerts pressure against the periphery of the flange 250 as the inner sleeve 200 continues to be inserted into the outer sleeve 500. When the lower lip 514 of the outer sleeve 500 encounters the notch 260 in the flange, the outer sleeve 500 is permitted to partially contract (or partially relax from flexing), thereby relieving some of the pressure being applied by the lower lip 514 against the flange 250 and securing the lower lip 514 within the notch 260. In this position, the inner face 556 of the lower lip 514 is disposed within the notch 260 near the flattened portion of the lower boundary 261 of the notch 260, and the beveled surface 558 of the lower lip 514 is disposed within the notch 260 against the sloped portion of the lower boundary 261 of the notch 260 (FIG. 35). The outer sleeve 500 is thereby retained on the inner sleeve 200 via pressure applied by the lower lip 514 of the outer sleeve 500 against the flange 250 of the inner sleeve 200 within the notch 260, the pressure (or clamping force) resulting from the expansion of the outer sleeve 500.

In this manner, the flange 250 (e.g., the radially outward projection of the flange 250; the radial depth of the notch 260; the length of the flattened portion of the lower boundary 261 of the notch 260 versus the length of the sloped portion of the lower boundary 261 of the notch 260; and the angle of the sloped portion of the lower boundary 261 of the notch 260) is optimized to enable the outer sleeve 500 to impart enough of a clamping force on the flange 250 to retain the lower lip 514 within the notch 260 during transport/seating of the transfer set 100 on a vial, yet permit longitudinal displacement of the second assembled unit 800 downward over the lower segment 204 of the inner sleeve 200 during capping of a vial, as described in more detail below.

When the lower lip 514 is seated within the notch 260, the cams 608, 612 of the cap 600 are generally mated with followers 428, 430 of the spike 400 (i.e., the cam surfaces 616, 618 of the cap 600 are longitudinally spaced apart from the follower surfaces 442, 444 of the spike 400 such that the cam surfaces 616, 618 and the follower surfaces 442, 444 matingly face one another in spaced relation) (FIG. 35). The first assembled unit 700 and the second assembled unit 800 are, therefore, connected together to conjointly form the assembled configuration of the transfer set 100 illustrated in FIGS. 33-35. The assembled transfer set 100 can be stored or transported for subsequent attachment to (i.e., seating or capping on) a vial, as set forth in more detail below.

With reference now to FIG. 36, the transfer set 100 is configured to facilitate transferring liquid into, and/or outer of, an enclosure (e.g., a sealed vial 900). In the illustrated embodiment, the vial 900 is hollow and includes a body 902, an annular neck 904 extending upward from the body 902, and an annular rim 906 extending outward from the neck 904. The neck 904 has an exterior surface 908, and the rim 906 has a peripheral edge 910 and a side surface 912. The body 902 defines a volume for containing a substance (e.g., a lyophilized medicinal drug), and the neck 904 defines a headspace of the vial 900. Seated on the rim 906 and extending into the neck 904 is a stopper 914 that seals the vial 900, the stopper 914 having a flange portion 916 covering the rim 906 (but not the peripheral edge 910), and a central portion 918 (within the flange portion 916) covering the headspace of the neck 904. Notably, the central portion 918 is configured to be punctured when breaking the seal of the stopper 914 to introduce a substance into, or withdraw a substance from, the volume (e.g., to introduce a diluent into the vial 900 for mixing with a drug stored within the volume, and to withdraw the mixture from the vial 900 for self-administering the mixture via a syringe). In other embodiments, the vial 900 may be any suitable enclosure configured in any suitable manner to contain any suitable substance that facilitates enabling the transfer set 100 to function as described herein.

In the illustrated embodiment, the sealed vial 900 may be provided to a user with the transfer set 100 permanently connected to (or “capped” on) the vial 900, thereby enabling the user to perform a reconstitution operation by simply activating the transfer set 100 and attaching a syringe to the activated transfer set 100 (as set forth below). In other words, the vial 900 is to be capped with the transfer set 100 in a manner that does not break the seal of the vial 900 (e.g., in a manner that maintains sterility throughout the shelf-life of the substance contained within the vial 900), yet enables the seal of the vial 900 to be broken when the user desires to perform a reconstitution operation. As such, the vial 900 and the transfer set 100 are configured to be provided to the user as a single, conjoint assembly (i.e., a kit) in which the transfer set 100 is permanently (or irremovably) connected to the vial 900 and is disposable with the vial 900 after a reconstitution operation has been performed and the resulting mixture has been withdrawn from the vial 900 (i.e., the transfer set 100 is configured for one-time, disposable use).

With reference again to FIG. 35 and to FIGS. 36 and 37, in order to “cap” the vial 900 with the assembled transfer set 100 (FIG. 35), the assembled transfer set 100 is first seated on the stopper 914 of the vial 900 by inserting the rim 906 of the vial 900 into the lower segment 204 of the inner sleeve 200. However, before seating the transfer set 100 on the vial 900, the cams 608, 612 of the cap 600 are preferably dipped in a lubricant such that the tips 610, 614 of the cams 608, 612 (and at least a portion of the cam surfaces 616, 618) are coated with the lubricant. By applying the lubricant to the cams 608, 612, smoother activation of the transfer set 100 is facilitated by minimizing friction between the cam surfaces 616, 618 and the follower surfaces 442, 444, as set forth in more detail below.

As the rim 906 of the vial 900 is being inserted into the lower segment 204 of the inner sleeve 200, the teeth 252 of the inner sleeve 200 contact the peripheral edge 910 of the rim 906 of the vial 900, and the inner beveled edges 278 of the teeth 252 slide downward along the peripheral edge 910 to drive the teeth 252 radially outward, thereby flexing (or bending) the joints 254 of the teeth 252 and tensioning (or spreading) the webs 256 between the teeth 252 such that a diameter of the lower segment 204 expands to receive the rim 906. After the lower segment 204 is in its expanded state (i.e., after the inner beveled edges 278 have slid downward beyond the peripheral edge 910 of the rim 906), the inner protuberance 276 of each tooth 252 begins to apply pressure to the side surface 912 of the rim 906 as the teeth 252 slide longitudinally downward along the side surface 912.

Having slid past the side surface 912 of the rim 906, the pressure applied by the inner protuberances 276 against the side surface 912 of the rim 906 is relieved, enabling the joints 254 to unbend and the webs 256 to substantially relax from being in tension, thereby contracting the lower segment 204 and driving the inner protuberances 276 radially inward toward the exterior surface 908 of the neck 906 of the vial 900, the lower segment 204 of the inner sleeve 200 substantially conforming to the shape of the rim 906 of the vial 900 such that the rim 906 occupies the inner depression 274 of the lower segment 204. In this manner, the bulkhead 248 (FIG. 27) of the inner sleeve 200 is seated atop the stopper 914, with the prong 288 (FIG. 27) contacting (or somewhat compressing) the stopper 914 and circumscribing the central portion 918 of the stopper 914. In this position, while the transfer set 100 has been seated on the vial 900, the vial 900 has not yet been “capped” with the transfer set 100 (i.e., the transfer set 100 can still be removed from the vial 900 and has yet to be permanently fixed on the vial 900).

Notably, if the teeth 252 of the inner sleeve 200 are inadvertently bent inward and caught between the flange portion 916 of the stopper 914 and the bulkhead 248 (FIG. 27) as the transfer set 100 is being seated on the vial 900, the sealing of the transfer set 100 on the vial 900 (which is described in more detail below) can be compromised. To prevent such inward bending of the teeth 252, the teeth 252, the joints 254, and the webs 256 of the inner sleeve 200 are stiff enough to prevent the teeth 252 from being inwardly flexed to the extent of being trapped between the stopper 914 and the bulkhead 248 during seating of the transfer set 100 on the vial 900 (i.e., the teeth 252, the joints 254, and/or the webs 256 are stiff enough that the teeth 252 cannot flex inwardly at a 90° angle (or, alternatively, a 45° angle) relative to the longitudinal axis Y, which is shown in FIG. 27). By rendering the teeth 252 incapable of flexing inwardly to such a degree, better alignment of the teeth 252 is achieved when the inner sleeve 200 is seated on the vial 900, which facilitates ensuring a higher quality seal for each capped vial 900, a more consistent sealing operation from one capped vial 900 to the next capped vial 900, and an upright orientation of each inner sleeve 200 on its respective vial 900 after seating and before capping (e.g. while the transfer set 100 is traveling down the capping line after having been seated (but not yet capped) on the vial 900).

Referring still to FIGS. 35-37, after the assembled transfer set 100 is seated on the vial 900, the vial 900 is to be capped with the transfer set 100 by imparting a longitudinal force F (FIG. 35) to the closed top wall 602 of the cap 600 (and/or the outer sleeve 500) such that the overhang surface 624 transmits any longitudinal force F imparted on the cap 600 to the outer sleeve 500, thereby driving the cap 600 and the outer sleeve 500 downward (conjointly together) to dislodge the lower lip 514 of the outer sleeve 500 from the notch 260 of the flange 250 (i.e., the second assembled unit 800 is displaced longitudinally downward relative to the first assembled unit 700 to cap the vial 900). More specifically, the longitudinal force F imparted to the outer sleeve 500 (e.g., via the cap 600) causes the beveled surface 558 of the lower lip 514 to slide downward along the sloped portion of the lower boundary 261 of the notch 260, again causing the outer sleeve 600 to expand radially outward such that the inner face 556 of the lower lip 514 slides downward along the exterior of the flange 250 while maintaining a radially directed pressure thereagainst.

Once the lower lip 514 slides downward past the flange 250 (i.e., once the lower lip 514 encounters the outer depressions 264 of the lower segment 204), the radial pressure being applied by the lower lip 514 on the flange 250 is relieved, and the outer sleeve 500 is permitted to contract, driving the lower lip 514 into the outer depressions 264. With continued application of the longitudinal force F to the cap 600 and/or the outer sleeve 500, the outer sleeve 500 continues its downward displacement relative to the lower segment 204 of the sleeve 200 until the bottom surface 504, the beveled surface 558, and/or the inner face 556 of the outer sleeve 500 encounter the sloped lower boundaries 266 of the outer depressions 264 and slide downward along the sloped lower boundaries 266 to drive the teeth 252 (i.e., the inner protuberances 276 and the outer protuberances 268) radially inward and toward the exterior surface 908 of the neck 904 of the vial 900.

After the lower lip 514 of the outer sleeve 500 slides past the lower boundaries 266 of the outer depressions 264, the lower lip 514 continues to slide downward along the outer protuberances 268 until encountering the outer beveled edges 272 of the inner sleeve 200, at which time the lower lip 514 grips (i.e., wraps underneath) the outer beveled edges 272 (FIG. 37) with the inner surface 506 of the outer sleeve 500 pressing the teeth 252 against the exterior surface 908 of the neck 904 of the vial 900. Notably, simultaneous to the lower lip 514 gripping the outer beveled edges 272, the upper lip 512 seats on the edge 258 of the flange 250. In this manner, the outer sleeve 500 is permanently fixed on the lower segment 204 of the inner sleeve 200, with the lower lip 514 of the outer sleeve 500 engaging the teeth 252 to prevent longitudinally upward displacement of the outer sleeve 500 relative to the inner sleeve 200, and with the upper lip 512 of the outer sleeve 500 engaging the flange 250 of the inner sleeve 200 to prevent longitudinally downward displacement of the outer sleeve 500 relative to the inner sleeve 200. In such an arrangement, the vial 900 is said to be “capped” with the transfer set 100.

During the downward displacement of the outer sleeve 500 relative to the inner sleeve 200, the tabs 622 of the cap 600 remain disposed between the ridges 544, 546 of the outer sleeve 500 as shown in FIG. 31 (i.e., the transfer set 100 has not yet been activated). In that regard, while the cam surfaces 616, 618 of the cap 600 remain facing the follower surfaces 442, 444 of the spike 400 (in mating relation) during the longitudinal displacement of the cap 600 relative to the spike 400, the longitudinal spacing between the cam surfaces 616, 618 and the follower surfaces 442, 444 decreases during the displacement such that the cam surfaces 616, 618 are contacting, or are closely spaced from, the follower surfaces 442, 444 when the outer sleeve 500 becomes permanently fixed to the inner sleeve 200 as illustrated in FIG. 37.

Moreover, when the vial 900 is capped with the transfer set 100, the interior space within the cap 600 must be sealed in order to maintain internal sterility until activation of the transfer set 100 has begun. To provide such a seal, as the second assembled unit 800 is displaced relative to the first assembled unit 700, the bottom edge 604 of the cap 600 annularly contacts (i.e., compresses and/or bites into) the gasket 300, and the magnitude by which the stopper 914 is compressed by the prong 288 increases, thereby sealing the interior space of the cap 600 via the interface between the cap 600 and the gasket 300, and the interface between the prong 288 and the stopper 914. Notably, the depth of the seat 224 for the gasket 300 has been optimized to enable the gasket 300 to protrude beyond the outer surface 214 of the upper segment 202 of the inner sleeve 200 enough to maximize sealing between the gasket 300 and the cap 600 when the cap 600 seats over (and/or bites into) the gasket 300 and minimize frictional opposition of the gasket 300 against rotation of the cap 600 when activating the transfer set 100, as set forth in more detail below. In that regard, the bottom edge 604 of the cap 600 may be shaped to optimize the seal between the gasket 300 and the cap 600 when the cap 600 seats over (and/or bites into) the gasket 300 (e.g., the bottom edge 604 may be rounded or beveled to enable sealing contact with the gasket 300 without fracturing the gasket 300).

During capping of the vial 900 with the transfer set 100, the vial 900 travels along the capping line in an upright orientation alongside many other vials 900. As such, maintaining the upright orientation of each vial 900 is desirable, given that one vial 900 tipping over can cause a domino-effect on the capping line. To inhibit tipping after the transfer set 100 has been seated (or capped) on the vial 900, the weight of the transfer set 100 has been minimized, thereby reducing the top-heaviness of the transfer set 100 on the vial 900 after capping. One example of this weight-conscious design is the spike 400 being hollow between the outer body 422 and the inner body 420, as well as the teeth 252 having recesses 270 (which is best illustrated in FIG. 8). This reduction in weight minimizes problems associated with assembly, reduces annoyance from a user standpoint, and lowers the cost of material when manufacturing the device.

In the capped configuration (shown in FIG. 37 without the vial 900), the transfer set 100 and the vial 900 can be stored or transported until reconstitution of the substance inside the vial 900 is desired (i.e., the vial 900 remains sealed even though the vial 900 has been capped with the transfer set 100). When reconstitution of the substance within the vial 900 is desired, however, a user grasps the outer sleeve 500 in one hand (e.g., grips the gripping ring 562 and/or the indented (or flattened) gripping areas of the outer surface 508 of the outer sleeve 500, while also grasping the cap 600 in the other hand (i.e., gripping the gripping surfaces 640 and/or the indented (or flattened) gripping areas 638 of the side wall 606 of the cap 600). Then, the user manually rotates the cap 600 relative to the outer sleeve 500 in the direction indicated by arrow 642 (i.e., in a counterclockwise direction when the cap 600 is viewed from above or, in other words, a clockwise direction R when the outer sleeve 500 is viewed from below as in FIG. 31).

Referring back to FIGS. 31 and 32, as the user rotates the cap 600, each of the tabs 622 of the cap 600 traverses its respective second ridge 546 of the outer sleeve 500, and the first flat surface 632 of each associated guide formation travels along the second step 538 of its corresponding inclined ledge 522 (i.e., either in contact therewith, or spaced closely therefrom as shown in FIG. 32). After each tab 622 has traveled circumferentially beyond the base 526 of its associated inclined ledge 522, the sloped surface 636 of each guide formation encounters the second slope 540 of its corresponding inclined ledge 522. Upon continued rotation of the cap 600, the sloped surface 636 of each guide formation contacts and slides upward along the second slope 540 of the corresponding inclined ledge 522 until traversing the peak 528 of the inclined ledge 522 such that the first flat surface 632 contacts, and slides along, the top surface 502 of the outer sleeve 500.

Notably, when the sloped surface 636 of each guide formation slides up the second slope 540 of the corresponding inclined ledge 522, the overhang surface 624 of the cap 600 separates from contact with (or for further spaces away from) the top surface 502 of the outer sleeve 500, and the bottom edge 604 of the cap 600 removes least some pressure from (or further spaces away from) the gasket 300. Additionally, the pawls 530 sequentially traverse the teeth 626 of the cap 600 (i.e., each pawl 530, interacting with its associated set of teeth 626 of the cap 600, flexes radially outward to slide over each tooth 626, and subsequently snaps radially inward into the next interdental space), thereby enabling continued rotation of the cap 600 in the clockwise direction R while preventing rotation of the cap 600 in the opposite direction. Moreover, because the pressure of the cap 600 on the gasket 300 is reduced or eliminated entirely, the gasket's frictional opposition to rotation of the cap 600 is likewise reduced or eliminated entirely, enabling easier rotation of the cap 600 relative to the outer sleeve 500 (i.e., through the majority of the distance over which the cap 600 rotates, the added frictional resistance of the gasket 300 (caused by the gasket 300 rubbing against the cap 600) is either reduced or not present at all).

Because the distal end 495 of the spike 400 is held within millimeters of the stopper 914 during transport and storage of the capped vial 900, even the slightest rotation of the cap 600 can cause the spike 400 to begin puncturing the stopper 914. As such, it is desirable to prevent the cap 600 from being rotated in the opposite direction once activation begins, and the first tooth 626 in each set has therefore been strategically positioned to be immediately (and fully) engaged by its respective pawl 530 once puncturing of the stopper 914 has begun. In this manner, once the tabs 622 have traversed their associated second ridges 546 and the pawls 530 have traversed the first tooth 626 of their associated sets of teeth 626), the activation process cannot be reversed. Rather, the user must continue rotating the cap 600 until activation of the transfer set 100 is complete, as set forth in more detail below. Notably, providing a pair of opposing pawls 530 (rather than a single pawl 530) is desirable to provide added strength that ensures counter-rotation is prevented.

With reference again to FIGS. 35-37, during rotation of the cap 600 relative to the outer sleeve 500, the cams 608, 612 interact with the followers 428, 430 to convert rotation of the cap 600 into translation of the spike 400. More specifically, the first cam surface 616 slides upward along the first follower surface 442, and the second cam surface 618 slides upward along the second follower surface 444. However, because rotation of the spike 400 relative to the inner sleeve 200 is prevented by the splined engagement of the spike 400 and the inner sleeve 200 (FIG. 28), and because longitudinal displacement of the cap 600 relative to the outer sleeve 500 is prevented by the tabs 622 being confined within the channel 542 (FIG. 32), the rotation of the cams 608, 612 causes the spike 400 to translate longitudinally downward toward the stopper 914 of the vial 900.

Now referring back to FIG. 27, at the outset of the spike 400 being translated downward by the cap 600, the catches 452, 454 of the spike 400 begin to dislodge from the upper apertures 216 of the inner sleeve 200, with the oblique lower surfaces 458 of the catches 452, 454 sliding downward along the lower periphery of the upper apertures 216, thereby displacing the clip 440 radially inward and deeper into the second alcove 438 such that the legs 446, 448 of the clip 440 flex to essentially spring-load the clip 440. After the catches 452, 454 have been dislodged from the upper apertures 216, the crossbar 450 encounters the base 244 of the ramp 240 within the passage 208 of the inner sleeve 200, and the crossbar 450 slides downward along the ramp 240 from the base 244 to the peak 246 as translation of the spike 400 continues. Because the projection of the ramp 240 into the passage 208 increases from the base 244 of the ramp 240 to the peak 246 of the ramp 240, the magnitude of the flexing (or bending) experienced by the legs 446, 448 increases continuously as the crossbar 450 slides down the ramp (and the magnitude of the spring-loading of the clip 440 correspondingly increases continuously as the crossbar 450 slides down the ramp 240).

Once the crossbar 450 traverses the peak 246 of the ramp 240, the crossbar 450 encounters the base region 220 of the lower aperture 218, and the catches 452, 454 encounter the leg regions 222 of the lower aperture 218. As such, the clip 440 is permitted to snap radially outward (releasing the spring-loading of the clip 440) to locate the crossbar 450 beneath the peak 246 of the ramp 240 and to insert the catches 452, 454 into the leg regions 222 of the lower aperture 218. In this manner, upward displacement of the clip 440 (and, therefore, the spike 400) is limited by the interference of the crossbar 450 with the ramp 240 and the interference of the catches 452, 454 with the upper periphery of the leg regions 222 of the lower aperture 218. Moreover, the stop 242 provides a lower limit for longitudinally downward displacement of the clip 440 (i.e., the crossbar 450 is positioned to contact the stop 242 upon excessive downward displacement of the spike 400). In such an arrangement, the clip 440 is locked in the lower aperture 218 to retain the spike 400 in a second fixed position. Simultaneous to the crossbar 450 of the clip 440 sliding down the ramp 240, the distal end 495 of the tip segment 406 of the spike 400 passes through the neck 280 of the passage 208 (i.e., passes through the bulkhead 248) to encounter and puncture the central portion 918 of the stopper 914 of the vial 900 (FIG. 36).

Notably, during activation of the transfer set 100, there are various contributors to resistance against translation of the spike 400. For example, the catches 452, 454 of the spike 400 must be dislodged from the upper apertures 216 of the inner sleeve 200; the crossbar 450 of the clip 440 of the spike 400 must then slide down the ramp 240 of the inner sleeve 200 against the continuously increasing resistance imparted by flexing legs 446, 448 of the clip 440 on the ramp 240; and the tip segment 406 of the spike 400 must then puncture the stopper 914 before entering the vial 900. In order to facilitate reducing the torque needed to rotate the cap 600 and to provide a more constant torque requirement throughout the entire rotation of the cap 600, the slope of the follower surfaces 442, 444 on the spike 400 has been configured to vary in accordance with the varying resistance imparted on the spike 400 during translation. In other words, the follower surfaces 442, 444 have a different slope at locations where more resistance is anticipated than at locations where less resistance is anticipated. The slope of each follower surface 442, 444 is, therefore, not constant from the top of the follower surface 442, 444 to the bottom of the follower surface 442, 444. Rather, the slope is configured to provide the greatest mechanical advantage where the resistance is greatest and the least mechanical advantage where resistance is least. Similarly, the cam surfaces 616, 618 (FIG. 24) may also have a different slope at locations where more resistance is anticipated than at locations where less resistance is anticipated. Thus, the slope of each cam surface 616, 618 may not, therefore, be constant from top to bottom. Rather, the slope of the cam surfaces 616, 618 may too be configured to provide the greatest mechanical advantage where the resistance is greatest and the least mechanical advantage where resistance is least. This varying slope enables easier activation of the transfer set 100 by a user.

Moreover, when the cap 600 is rotated and the cams 608, 612 engage the followers 428, 430 to translate the spike 400, the cams 608, 612 naturally tend to bow radially outward (to point the tips 610, 614 radially inward) in response to driving the spike 400 downward. As such, any potential for a radially inward obstruction to the cam tips 610, 614 traveling up the follower surfaces 442, 444 should be mitigated. In this manner, the shoulder 434 (FIG. 11) inhibits the first tip 610 of the first cam 608 from entering into the mold-release 432 near the top of the first follower surface 442 as the cams 608, 612 drive the followers 428, 430 downward and potentially bow radially inward, thereby lessening the possibility that the transfer set 100 malfunctions during activation.

Additionally, while the spike 400 is configured to be translatable within the inner sleeve 200 from the first fixed position to the second fixed position, inadvertent progression and regression of the spike 400 from each of these two fixed positions is undesirable. Thus, because the catches 452, 454 are inserted into the upper apertures 216 of the inner sleeve 200, the flat upper surfaces 456 of the catches 452, 454 inhibit inadvertent dislodging of the spike 400 upward from the first fixed position. Given that the oblique lower surfaces 458 of the catches 452, 454 are configured to promote easier dislodging of the catches 452, 454 downward from the upper apertures 216, the ramp 240 helps to limit downward displacement of the spike 400 (by providing resistance against the clip 440) in the event that the spike 400 becomes inadvertently dislodged downward from the first fixed position. In that regard, the flexibility of the legs 446, 448 of the clip 440 has been optimized to provide sufficient resistance against the ramp 240 to limit downward displacement of the spike 400 in the event that the spike 400 becomes inadvertently dislodged, without excessively resisting an intended downward displacement of the spike 400 during activation of the transfer set 100.

Referring again to FIGS. 31 and 32, after the stopper 914 has been punctured, activation of the transfer set 100 is complete, and continued rotation of the cap 600 causes each of the tabs 622 to align with the slot 516 that opposes the slot 516 into which the tab 622 was inserted (i.e., during activation of the transfer set 100, each tab 622 rotates substantially halfway around the outer sleeve 500 within the channel 542, from one slot 516 (i.e., the “slot 516 of ingress” into the channel 542) to the opposed slot 516 (i.e., the “slot 516 of egress” from the channel). Thus, the slot 516 of ingress for one of the tabs 622 is the slot 516 of egress for the other of the tabs 622, and vice versa. In this manner, the cap 600 cannot be removed from the outer sleeve 500 between its corresponding slot 516 of ingress and slot 516 of egress. However, upon reaching its associated slot 516 of egress, each tab 622 is able to be removed from the channel 542, thereby rendering the cap 600 removable from the outer sleeve 500.

Notably, the user is provided with a tactile indication that excessive rotation of the cap 600 after complete activation of the transfer set 100 is not possible and is, thereby, alerted that the cap 600 is to be removed from the outer sleeve 500 in order to perform a reconstitution operation after activation is complete. More specifically, if the user attempts to rotate the tabs 622 of the cap 600 beyond their associated slots 516 of egress from the channel 542, each of the tabs 622 contacts the base 526 of the inclined ledge 522 that is nearby the corresponding slot 516 of egress, thereby preventing excessive rotation after activation is complete. Moreover, because the teeth 626 of the cap 600 prevent counter-rotation of the cap 600, because the first flat surface 632 of the guide formation (FIG. 21) is seated on the top surface 502 of the outer sleeve 500 and therefore prevents longitudinally downward displacement of the cap 600 within the outer sleeve 500, and because the base 526 of the inclined ledge 522 associated with the slot 516 of egress prevents excessive rotation of the cap 600 after activation, the user is not able to displace the cap 600 in any direction other than longitudinally upward. In this manner, removal of the cap 600 from the outer sleeve 500 after activation of the transfer set 100 is more intuitive.

Referring back to FIG. 14, upon removal of the cap 600 from the outer sleeve 500, the connector segment 404 of the spike 400 is exposed, and the user is permitted to connect a syringe (e.g., a syringe containing a diluent) to the connector segment 404 by inserting a male fitting of the syringe into the female fitting 410 of the connector segment 404 and threading the syringe onto the threads 412, 414 of the connector segment 404, thereby connecting the syringe to the conduit 408 of the spike 400 in fluid communication. Notably, if the connector segment 404 had been provided with threads that are longer than is needed to achieve a firm attachment of the syringe to the spike 400, the user may be inclined to excessively screw the syringe onto the connector segment 404 until no threads remain visible. This excessive screwing of the syringe by the user (after a firm attachment has been made) can result in damage to the syringe and/or the connector segment 404 of the spike 400. The connector segment 404 of the illustrated spike 400 has, therefore, been provided with threads 412, 414 having optimized circumferential and longitudinal extensions on the connector segment 404 in order to provide the user with a visual cue to stop screwing the syringe onto the spike 400 once the syringe is sufficiently attached to the spike 400. Excessive screwing of the syringe onto the connector segment 404 is thereby discouraged.

Upon initiating the discharge of liquid (e.g., diluent) from the syringe into the conduit 408 of the spike 400, the liquid flows through the liquid filter 418 and ultimately contacts the bounding surface 489 of the tip segment 406 such that the liquid is discharged from the ports 497 into the vial 900. As the liquid discharges from the ports 497 and enters the vial 900, air from within the vial 900 exits the vial 900 through the inlet 499 of the tip segment 406 and flows through the airflow path 490 into the vent 492 to be exhausted from the vent 492 into the first alcove 436 via the air filter 494. After discharging the liquid of the syringe into the vial 900 and mixing the liquid with the substance of the vial 900, the mixture can be subsequently withdrawn from the vial 900 into the syringe via the ports 497 such that the mixture flows through the liquid filter 418 and into the syringe. Moreover, as the mixture is withdrawn from the vial 900, air from within the first alcove 436 is drawn into the vial 900 through the air filter 494, the vent 492, the airflow path 490, and the inlet 499.

Notably, in medicinal drug reconstitution, discharging the diluent directly at the medicinal drug at the bottom of the vial 900 can cause a foaming effect, and foaming is undesirable, especially with protein drugs. As such, the ports 497 of the tip segment 406, and the concave bounding surface 489 of tip segment 406 at the end of the conduit 408, are configured to facilitate discharging the diluent radially toward the side walls of the body 902 of the vial 900 (e.g., substantially perpendicular to the longitudinal axis Y), rather than longitudinally downward toward the lyophilized drug disposed at the bottom of the vial 900. This radial discharging of the diluent reduces foaming within the vial 900 during reconstitution. Moreover, the upwardly offset disposition of the open bottom 493 of the inlet 499 relative to the open bottoms 491 of the ports 497, in addition to the scalloped shape of the inlet 499, facilitate inhibiting droplets of liquid that form at the distal end 495 of the tip segment 406 from being drawn into the airflow path 490 during reconstitution.

Additionally, because the point of connection between the body segment 402 and the connector segment 404 of the spike 400 can be exposed to significant stresses during manufacture (i.e., forces associated with withdrawal from the mold) and during use (i.e., forces associated with attachment and use of a syringe), it is possible that these stresses could cause cracks in the spike 400 near the connection. In that regard, the thickened interface 416 of the connector segment 404 and the body segment 402 in the illustrated embodiment adds structural integrity to the spike 400 and minimizes the possibility that the spike 400 would crack during manufacture or use of the transfer set 100.

Moreover, because the spike 400 punctures the stopper 914 of the vial 900 during activation of the transfer set 100, it is possible for particulates from the stopper 914 to enter the vial 900. It is important in medicinal applications, however, that these or any other particulates are prevented from being withdrawn from the vial 900 into the syringe. Thus, the built-in, ultrasonically welded liquid filter 418 in the conduit 408 inhibits particulates from entering the syringe. Similarly, the hydrophobic air filter 494 disposed over the vent 492 of the spike 400 inhibits particulate entry into the vial 900 through the airflow path 490 and resists wetting of the air filter 494 that can result from moisture entering and exiting the vial 900, given that wetting of the air filter 494 can cause the air filter 494 to clog and can affect the sterility of the transfer set 100.

Lastly, after withdrawing the mixture from the vial 900 into the syringe, reconstitution via the transfer set 100 is complete, and the used transfer set 100 is to be disposed of, along with the used vial 900. Notably, because the transfer set 100 is permanently fixed to the vial 900, reuse of a used transfer set 100 is prevented, as the used vial 900 cannot be separated from the used transfer set 100 without destroying the used transfer set 100.

Accordingly, in one embodiment a transfer set for transferring liquid into or out of a vial sealed by a stopper generally comprises an inner sleeve having a passage extending through the inner sleeve along a longitudinal axis, and an outer sleeve configured for connecting the inner sleeve to the vial such that the passage is disposed above the stopper of the vial. The transfer set further comprises a spike including a follower, wherein the spike is disposed within the passage of the inner sleeve and is configured for longitudinal translation along the passage to puncture the stopper, and a cap configured for insertion into the outer sleeve such that the cap is connected to the outer sleeve and is detachable from the outer sleeve via rotation of the cap relative to the outer sleeve. The cap includes a closed top wall, an annular side wall extending from the closed top wall to define an open bottom and an interior space of the cap, and a cam disposed within the interior space, wherein the inner sleeve and the spike extend into the interior space when the cap is connected to the outer sleeve, and wherein, as the cap is rotated relative to the outer sleeve for detachment of the cap from the outer sleeve, the cam interacts with the follower to translate the spike toward the stopper for puncturing the stopper.

In another embodiment, the outer sleeve of the transfer set comprises a rim for retaining the cap rotatably connected to the outer sleeve. In another embodiment, the cap of the transfer set further comprises a plurality of tabs configured for disposition beneath the rim for retaining the cap rotatably connected to the outer sleeve. In another embodiment, the cap further comprises a pair of ridges disposed beneath the rim, with the ridges configured to be traversed by one of the tabs during rotation of the cap. In another embodiment, each of the ridges has a first side and a second side, the first side being oriented for traversal by the one of the tabs before the second side, and wherein the second side is more steeply inclined than the first side. In another embodiment, the outer sleeve of the transfer set further comprises a plurality of slots defined in the rim, each of the slots sized to receive one of the tabs. In another embodiment, the plurality of tabs comprises a pair of opposed tabs and the plurality of slots comprises a pair of opposed slots, with each of the slots providing ingress through the rim for one of the tabs and egress through the rim for the other of the tabs. In another embodiment, the rim comprises an inclined ledge for driving the cap away from the rim during rotation of the cap. In another embodiment, the inclined ledge is stepped.

In another embodiment, the cap of the transfer set further comprises a plurality of circumferentially arranged teeth, and the outer sleeve comprises a pawl for engaging the teeth to provide ratcheting of the cap during rotation of the cap. In another embodiment, the pawl is a flexible finger that flexes to traverse each of the teeth. In another embodiment, the outer sleeve comprises a pair of pawls for engaging the teeth to provide ratcheting of the cap during rotation of the cap.

In one embodiment, a transfer set for transferring liquid into or out of a vial sealed by a stopper generally comprises a first conjoint unit including an inner sleeve and a spike disposed within the inner sleeve, wherein the inner sleeve is configured for seating on the stopper of the sealed vial and wherein the spike is configured for translation within the inner sleeve to puncture the stopper. The transfer set further comprises a second conjoint unit including an outer sleeve and a cap connected to the outer sleeve such that the cap is detachable from the outer sleeve by rotating the cap relative to the outer sleeve. The outer sleeve is configured for connection to the inner sleeve in a first connected state, in which the first conjoint unit is removably connected to the sealed vial, and a second connected state, in which the first conjoint unit is irremovably connected the sealed vial, the first conjoint unit and the second conjoint unit being aligned along a longitudinal axis when the second conjoint unit is connected to the first conjoint unit. By applying a longitudinal force to the second conjoint unit when the second conjoint unit is connected to the first conjoint unit, the second conjoint unit is configured for longitudinal displacement relative to the first conjoint unit to convert the connection of the second conjoint unit and the first conjoint unit from the first connected state to the second connected state. By rotating the cap relative to the outer sleeve to detach the cap from the outer sleeve in the second connected state, the cap translates the spike to puncture the stopper.

In another embodiment, the outer sleeve of the transfer set comprises a rim, the cap being connected to the outer sleeve such that, when the longitudinal force is applied to the cap, the cap transmits the longitudinal force to the outer sleeve by being seated on the rim of the outer sleeve. In another embodiment, the cap of the transfer set comprises an overhang surface configured for seating on the rim to transmit the longitudinal force from the cap to the outer sleeve. In another embodiment, the cap comprises a plurality of tabs configured to be disposed beneath the rim when the cap is connected to the outer sleeve, with the tabs preventing detachment of the cap from the outer sleeve prior to rotation.

In another embodiment, the inner sleeve of the transfer set comprises a flange, with the outer sleeve configured for connection to the flange in the first connected state. In another embodiment, the outer sleeve comprises a lower lip configured to apply a clamping force on the flange for connecting the outer sleeve to the flange in the first connected state. In another embodiment, the flange comprises a notch, with the lower lip configured to be seated in the notch for connecting the outer sleeve to the flange in the first connected state by applying the clamping force on the flange within the notch. In another embodiment, the lower lip comprises a beveled surface configured to drive the lower lip out of the notch when the longitudinal force is applied to the second conjoint unit such that the second conjoint unit is displaceable relative to the first conjoint unit. In another embodiment, the notch has a sloped lower boundary, with the beveled surface of the lower lip being configured to slide along the sloped lower boundary to drive the lower lip out of the notch when the longitudinal force is applied to the second conjoint unit.

In another embodiment, the inner sleeve of the transfer set comprises a plurality of teeth, with the outer sleeve and the teeth being configured to collectively maintain the first conjoint unit irremovable from the sealed vial in the second connected state. In another embodiment, the inner sleeve comprises a plurality of webs, with each of the webs spanning adjacent ones of the teeth to facilitate connecting the first conjoint unit to the sealed vial in the first connected state and the second connected state. In another embodiment, each of the webs is generally U-shaped so as to be bent inwardly toward the vial when the first conjoint unit is connected to the vial.

In another embodiment, the inner sleeve of the transfer set comprises a plurality of grooves, and the outer sleeve comprises a plurality of tongues. The tongues are insertable into the grooves to align the inner sleeve with the outer sleeve when the outer sleeve is connected to the inner sleeve.

In one embodiment, a transfer set for transferring liquid into or out of a vial sealed by a stopper generally comprises a sleeve including a passage extending through the sleeve along a longitudinal axis and a longitudinally inclined ramp protruding into the passage, wherein the sleeve is configured to be connected to the vial such that the passage is disposed above the stopper. The transfer set further comprises a spike including a clip, the spike being disposed within the passage and configured for longitudinal translation along the passage to puncture the stopper, wherein the clip is configured to resiliently slide up the incline of the ramp as the spike is being translated along the passage.

In another embodiment, the sleeve of the transfer set comprises an aperture, and the clip comprises a catch for engaging the aperture to maintain the spike in a fixed position within the passage. In another embodiment, the sleeve comprises a plurality of internal splines, and the spike comprises a plurality of external splines, with the internal and external splines being configured to permit insertion of the spike into the inner sleeve in only one circumferential orientation of the spike, and wherein the clip is longitudinally aligned with the aperture in the one circumferential orientation. In another embodiment, the clip is substantially U-shaped and comprises a pair of legs and a crossbar extending between the pair of legs, with the legs being configured to bend as the crossbar slides up the incline of the ramp. In another embodiment, the ramp has a base and a peak, with the sleeve being configured such that, when the crossbar traverses the peak of the ramp, the legs are permitted unbend and the crossbar is thereafter positioned such that longitudinal translation of the spike toward the base of the ramp is limited due in part to interference between the crossbar and the ramp. In another embodiment, the sleeve further comprises a stop configured to limit longitudinal translation of the spike away from the ramp after the crossbar traverses the peak of the ramp due in part to interference between the crossbar and the stop.

In another embodiment, the sleeve of the transfer set comprises a pair of apertures and the clip comprises a pair of catches for engaging the pair of apertures to maintain the spike in a fixed position within the passage. In another embodiment, the sleeve further comprises a substantially U-shaped aperture having a pair of spaced-apart leg regions and the ramp comprises a base and a peak. The pair of apertures is located adjacent the base of the ramp and the substantially U-shaped aperture is located adjacent the peak of the ramp such that the pair of apertures is longitudinally aligned with the pair of leg regions. The pair of catches is configured to engage the pair of apertures before sliding along the base of ramp, and to engage the pair of leg regions after traversing the peak of the ramp. In another embodiment, each of the catches comprises an upper surface and a lower surface, the lower surface being oblique relative to the longitudinal axis when the spike is disposed within the passage. In another embodiment, the upper surface is substantially perpendicular to the longitudinal axis when the spike is disposed within the passage.

In one embodiment, a transfer set for transferring liquid into or out of a vial sealed by a stopper generally comprises a sleeve including a passage extending through the sleeve along a longitudinal axis, wherein the sleeve is configured for connection to the vial such that the passage is disposed above the stopper. The transfer set also comprises a spike disposed within the passage and configured for longitudinal translation along the passage to puncture the stopper when the sleeve is connected to the vial, the spike having a follower surface. The transfer set further comprises a cap including a cam surface, the cap being rotatably connected to the sleeve such that the cam surface contacts the follower surface. Rotating the cap causes the cam surface of the cap to interact with the follower surface of the spike to translate the spike toward the stopper for puncturing the stopper, wherein the follower surface has a slope that varies along the follower surface.

In another embodiment, the follower surface of the transfer set is generally helically sloped. In another embodiment, the cam surface of the transfer set is generally helically sloped.

In another embodiment, the spike of the transfer set comprises a pair of follower surfaces. In another embodiment, the follower surfaces are sloped in a generally double-helical manner. In another embodiment, the spike comprises a pair of cam surfaces. In another embodiment, the cam surfaces are sloped in a substantially double-helical manner. In another embodiment, the generally double-helical manner in which the cam surfaces are sloped generally mirrors the generally double-helical manner in which the follower surfaces are sloped.

In another embodiment, the cap of the transfer set has an interior space and the cam surface is disposed within the interior space. The cap is configured to receive the inner sleeve and the spike within the interior space such that the cam surface contacts the follower surface within the interior space of the cap.

In one embodiment, a transfer set for transferring liquid into or out of a vial sealed by a stopper generally comprises an inner sleeve comprising a passage extending through the inner sleeve along a longitudinal axis. The transfer set also comprises an outer sleeve having an annular exterior, and the outer sleeve is configured for connecting the inner sleeve to the sealed vial such that the passage is disposed above the stopper. The transfer set also comprises a spike configured to be disposed within the passage of the inner sleeve and to be longitudinally translated along the passage to puncture the stopper. The transfer set further comprises a cap having an annular exterior, and the cap is configured for connection to the outer sleeve over the inner sleeve and the spike such that the cap is detachable from the outer sleeve via rotation of the cap relative to the outer sleeve, wherein at least one of the sleeve exterior and the cap exterior has a plurality of annularly isolated gripping areas.

In another embodiment, the annularly isolated gripping areas are indented. In another embodiment, the annularly isolated gripping areas are flattened.

In another embodiment, the annularly isolated gripping areas are paired in substantially diametrically opposed relation. In another embodiment, the annularly isolated gripping areas define an oblong annular contour of the at least one of the sleeve exterior and the cap exterior.

In another embodiment, the annularly isolated gripping areas are formed by a resilient polymeric material. In another embodiment, the outer sleeve of the transfer set comprises an annular gripping ring formed from the resilient polymeric material.

In another embodiment, each of the outer sleeve and the cap of the transfer set comprises a visual alignment marker to provide visual indication that the outer sleeve and the cap are aligned. In another embodiment, at least one of the visual alignment markers is in the form of a guideline.

In another embodiment, the cap of the transfer set comprises a rotation-direction indicator. In another embodiment, the rotation-direction indicator is an arrow.

In one embodiment, a transfer set for transferring liquid into or out of a vial sealed by a stopper generally comprises a sleeve including a passage extending through the sleeve along a longitudinal axis, wherein the sleeve is configured to be connected to the vial such that the passage is disposed above the stopper. The transfer set further comprises a spike including a body segment, a connector segment extending from the body segment, and a tip segment extending from the body segment opposite the connector segment. The spike is disposed within the passage and is configured for longitudinal translation along the passage to puncture the stopper via the tip segment. A liquid conduit extends through the spike from the connector segment to the tip segment, and an airflow path extends through the spike from the body segment to the tip segment. The airflow path has a vent defined in the body segment, and the spike further comprises a liquid filter disposed within the conduit and an air filter covering the vent.

In another embodiment, the air filter of the transfer set is hydrophobic.

In another embodiment, the air filter of the transfer set is ultrasonically welded to the body segment.

In another embodiment, the tip segment of the transfer set comprises an inlet to the airflow path, with the inlet being scalloped. In another embodiment, the tip segment further comprises a plurality of ports and a concave bounding surface for discharging liquid from the conduit through the ports at an angle that is substantially perpendicular to the longitudinal axis. In another embodiment, each of the liquid ports and the inlet has an open bottom, the open bottom of the inlet being offset longitudinally upward from the open bottoms of the liquid ports.

In another embodiment, the body segment of the transfer set comprises an inner body and an outer body, with the body segment being hollow between the inner body and the outer body.

In another embodiment, the spike of the transfer set comprises a thickened interface at a junction of the connector segment and the body segment.

In another embodiment, the connector segment of the transfer set has a height and a circumference, with the connector segment comprising a thread that extends around only substantially half of the circumference and spans only substantially half of the height.

In another embodiment, the tip segment of the transfer set has a blunted distal end.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A transfer set for transferring liquid into or out of a vial sealed by a stopper, the transfer set comprising:
an inner sleeve comprising a passage extending through the inner sleeve along a longitudinal axis;
an outer sleeve configured for connecting the inner sleeve to the vial such that the passage is disposed above the stopper of the vial;
a spike comprising a follower, wherein the spike is disposed within the passage of the inner sleeve and is configured for longitudinal translation along the passage to puncture the stopper; and
a cap configured for insertion into the outer sleeve such that the cap is connected to the outer sleeve and is detachable from the outer sleeve via rotation of the cap relative to the outer sleeve, the cap comprising:
a closed top wall;
an annular side wall extending from the closed top wall to define an open bottom and an interior space of the cap; and
a cam disposed within the interior space,
wherein the inner sleeve and the spike extend into the interior space when the cap is connected to the outer sleeve, and
wherein, as the cap is rotated relative to the outer sleeve for detachment of the cap from the outer sleeve, the cam interacts with the follower to translate the spike toward the stopper for puncturing the stopper.

2. The transfer set of claim 1 wherein the outer sleeve comprises a rim for retaining the cap rotatably connected to the outer sleeve.

3. The transfer set of claim 2 wherein the cap further comprises a plurality of tabs configured for disposition beneath the rim for retaining the cap rotatably connected to the outer sleeve.

4. The transfer set of claim 1 wherein the cap further comprises a plurality of circumferentially arranged teeth and wherein the outer sleeve comprises a pawl for engaging the teeth to provide ratcheting of the cap during rotation of the cap.

5. The transfer set of claim 4 wherein the pawl is a flexible finger that flexes to traverse each of the teeth.

6. A transfer set for transferring liquid into or out of a vial sealed by a stopper, the transfer set comprising:
a first conjoint unit comprising an inner sleeve and a spike disposed within the inner sleeve, wherein the inner sleeve is configured for seating on the stopper of the sealed vial and wherein the spike is configured for translation within the inner sleeve to puncture the stopper; and
a second conjoint unit comprising an outer sleeve and a cap connected to the outer sleeve such that the cap is detachable from the outer sleeve by rotating the cap relative to the outer sleeve, wherein the outer sleeve is configured for connection to the inner sleeve in a first connected state, in which the first conjoint unit is removably connected to the sealed vial, and a second connected state, in which the first conjoint unit is irremovably connected the sealed vial, the first conjoint unit and the second conjoint unit being aligned along a longitudinal axis when the second conjoint unit is connected to the first conjoint unit,
wherein, by applying a longitudinal force to the second conjoint unit when the second conjoint unit is connected to the first conjoint unit, the second conjoint unit is configured for longitudinal displacement relative to the first conjoint unit to convert the connection of the second conjoint unit and the first conjoint unit from the first connected state to the second connected state, and
wherein, by rotating the cap relative to the outer sleeve to detach the cap from the outer sleeve in the second connected state, the cap translates the spike to puncture the stopper.

7. The transfer set of claim 6 wherein the outer sleeve comprises a rim, the cap being connected to the outer sleeve such that, when the longitudinal force is applied to the cap, the cap transmits the longitudinal force to the outer sleeve by being seated on the rim of the outer sleeve.

8. The transfer set of claim 6 wherein the inner sleeve comprises a flange, the outer sleeve configured for connection to the flange in the first connected state.

9. The transfer set of claim 6 wherein the inner sleeve comprises a plurality of teeth, the outer sleeve and the teeth being configured to collectively maintain the first conjoint unit irremovable from the sealed vial in the second connected state.

10. The transfer set of claim 6 wherein the inner sleeve comprise a plurality of grooves and wherein the outer sleeve comprises a plurality of tongues, the tongues being insertable into the grooves to align the inner sleeve with the outer sleeve when the outer sleeve is connected to the inner sleeve.

11. A transfer set for transferring liquid into or out of a vial sealed by a stopper, the transfer set comprising:
a sleeve comprising a passage extending through the sleeve along a longitudinal axis, wherein the sleeve is configured for connection to the vial such that the passage is disposed above the stopper;
a spike disposed within the passage and configured for longitudinal translation along the passage to puncture the stopper when the sleeve is connected to the vial, the spike comprising a follower surface; and
a cap comprising a cam surface, the cap being rotatably connected to the sleeve such that the cam surface contacts the follower surface,
wherein rotating the cap causes the cam surface of the cap to interact with the follower surface of the spike to translate the spike toward the stopper for puncturing the stopper, and
wherein the follower surface has a slope that varies along the follower surface.

12. The transfer set of claim 11 wherein the follower surface is generally helically sloped.

13. The transfer set of claim 11 wherein the spike comprises a pair of follower surfaces.

14. The transfer set of claim 13 wherein the follower surfaces are sloped in a generally double-helical manner.

15. The transfer set of claim 11 wherein the cap has an interior space and wherein the cam surface is disposed within the interior space, the cap being configured to receive the inner sleeve and the spike within the interior space such that the cam surface contacts the follower surface within the interior space of the cap.
